(19) United States
(12) Patent Application Publication
(10) Pub. No.: US 2025/0287428 A1
(43) Pub. Date: Sep. 11, 2025

(54) CHANNEL ACCESS OPERATIONS FOR C-RTWT

(71) Applicants: SONY GROUP CORPORATION, Tokyo (JP); SONY CORPORATION OF AMERICA, New York, NY (US)

(72) Inventors: Qing Xia, San Jose, CA (US); Salvatore Talarico, Los Gatos, CA (US)

(73) Assignees: SONY GROUP CORPORATION, Tokyo (JP); SONY CORPORATION OF AMERICA, New York, NY (US)

(21) Appl. No.: 19/065,245

(22) Filed: Feb. 27, 2025

Related U.S. Application Data
(60) Provisional application No. 63/563,328, filed on Mar. 9, 2024.
(60) Provisional application No. 63/644,025, filed on May 8, 2024.

(51) Int. Cl. H04W 74/0816; H04B 17/318; H04W 84/12

(52) U.S. Cl. CPC H04W 74/0816; H04B 17/328; H04W 84/12

(57) ABSTRACT

Controlling channel access for UHR devices performing a Coordinated-Restricted Target Wake Time (C-RTWT) to prevent interference between Service Periods (SPs) on overlapping BSSs (OBSS). The coordination mechanism creates different rules based on the type of network topology and scenarios detected. In one aspect, a back-to-back CF-End transmission is used to truncate the basic Network Allocation Vector (NAV) of the OBSS. New channel access rules control TXOP termination, overlapping quiet interval and C-RTWT SP sharing for stations across BSSs.

### CROSS-REFERENCE TO RELATED APPLICATIONS

This application claims priority to and the benefit of U.S. provisional patent application Ser. No. 63/563,328 filed on Mar. 9, 2024, incorporated herein by reference in its entirety. This application claims priority to and the benefit of U.S. provisional patent application Ser. No. 63/644,025 filed on May 8, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to Coordinated Restricted-Target Wake Time (C-RTWT) scheduling between adjacent Basic Service Sets (BSSs), and more particularly to a new protocol for increasing the ability of obtaining prioritized access to the channel when there are multiple BSSs.

### 2. Background Discussion

Restricted-Target Wake Time (R-TWT) was intended in single Basic Service Set (BSS) use in heavy deployment WLAN operations toward arriving at a consensus on non-overlapping schedules toward conserving power and reducing network congestion. However, when an Overlapping BSS (OBSS) is involved, there are often issues with interference that compromises the ability of stations to obtain prioritized channel access.

Accordingly, a need exists for apparatus and methods for properly coordinating R-TWT across multiple BSS.

### BRIEF SUMMARY

A Coordinated R-TWT (C-RTWT) process is described which prevents the OBSS from interfering with the R-TWT SP of the intended BSS. The protocol considers the network topology and its specifics, while providing new channel access rules for TXOP termination, overlapping quiet interval and C-RTWT SP sharing for APs and non-AP STAs in BSSx and BSSy, before, during, and after, the starting point of R-TWT SPs.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is a block diagram of a high level architecture for AP MLDs having multiple affiliated APs connected to a central controller.

FIG. 4 is a topology diagram of adjacent BSSs with non-interfering APs.

FIG. 5 is a topology diagram of adjacent BSSs with interfering APs.

FIG. 6 is a communications diagram of time domain overlapping SPs of adjacent BSSs which are not subject to spatial interference, according to at least one embodiment of the present disclosure.

FIG. 7 is a communications diagram of time domain overlapping SPs of adjacent BSSs with frequency division, according to at least one embodiment of the present disclosure.

FIG. 8 is a communications diagram of time domain overlapping SPs of adjacent BSSs with frequency division, according to at least one embodiment of the present disclosure.

FIG. 9 is a communications diagram of time domain overlapped SPs of adjacent BSSs with spatial division, according to at least one embodiment of the present disclosure.

FIG. 10 is a communications diagram of BSS1 with R-TWT SP for STA1 and BSS2 with R-TWT SP for STA2, according to at least one embodiment of the present disclosure.

FIG. 11 is a topology diagram of a TXOP holder as AP1 in a trigger-based R-TWT SP, according to at least one embodiment of the present disclosure.

FIG. 12 is a topology diagram of a TXOP holder as STA1 in a non-Trigger-enabled R-TWT SP, according to at least one embodiment of the present disclosure.

FIG. 13 is a topology diagram of a case in which the R-TWT scheduling AP does not interfere with an OBSS AP, nor is it interfering with the OBSS R-TWT member STAs.

FIG. 14 is a topology diagram of a case in which the R-TWT scheduling AP is receiving interference from the AP and/or the R-TWT member STAs from the OBSS.

FIG. 15 is a data field diagram of UHR capabilities and operations relevant subfields, according to at least one embodiment of the present disclosure.

FIG. 16 is a data field diagram of UHR C-RTWT negotiation relevant subfields, according to at least one embodiment of the present disclosure.

FIG. 17A and FIG. 17B is a flow diagram of channel access operations for C-TDMA-based C-RTWT, according to at least one embodiment of the present disclosure.

FIG. 18 is a communications diagram addressing the case in which a TXOP holder AP1 interferes with AP2, according to at least one embodiment of the present disclosure.

FIG. 19 is a communications diagram addressing the case in which a TXOP holder does not interfere with the OBSS AP, yet the TXOP responder is interfering with the OBSS AP, according to at least one embodiment of the present disclosure.

FIG. 20 is a communications diagram addressing a second case in which a TXOP holder does not interfere with the OBSS AP, and yet a TXOP responder can interfere with the OBSS AP, according to at least one embodiment of the present disclosure.

FIG. 21 is a communications diagram addressing the case in which a TXOP holder interferes with the OBSS AP, while the TXOP responder does not interfere with the OBSS AP, according to at least one embodiment of the present disclosure.

FIG. 22 is a communications diagram of addressing channel access for AP1, STA1 and STA2, according to at least one embodiment of the present disclosure.

FIG. 23 is a communications diagram of addressing channel access for AP2, STA3 and STA4, according to at least one embodiment of the present disclosure.

FIG. 24 is a communications diagram of applying an optional NAV-terminate sequence, according to at least one embodiment of the present disclosure.

FIG. 25 is a communications diagram of handshake frame exchange for C-RTWT sharing, according to at least one embodiment of the present disclosure.

FIG. 26 is a communications diagram of a handshake frame exchange with a relay for C-RTWT sharing, according to at least one embodiment of the present disclosure.

FIG. 27 is a communications diagram addressing the case in which BSS1 R-TWT SP terminated before the starting point of BSS2 R-TWT SP, according to at least one embodiment of the present disclosure.

FIG. 28 is a communications diagram of applying an optional NAV-terminate sequence, according to at least one embodiment of the present disclosure.

FIG. 29 is a communications diagram of a handshake frame exchange for C-RTWT sharing, according to at least one embodiment of the present disclosure.

FIG. 30 is a communications diagram addressing the case in which BSS1 R-TWT SP terminated at the starting point of BSS2 R-TWT SP, according to at least one embodiment of the present disclosure.

FIG. 31 is a communications diagram of a handshake frame exchange with relay for C-RTWT sharing, according to at least one embodiment of the present disclosure.

FIG. 32 is a communications diagram of C-RTWT scheduling-based channel access, according to at least one embodiment of the present disclosure.

### DETAILED DESCRIPTION

### 1. Introduction

The IEEE P802.11 bn project has been established to enhance the base functionalities of IEEE P802.11 be. The main purpose of IEEE P802.11 bn is to provide wireless connectivity for fixed, portable, and moving stations within a local area, but more importantly add the Ultra High Reliability (UHR) capability to a WLAN. The Ultra-High Reliability (UHR) capability requires increased throughput, reduced latency, and reduced MAC Protocol Data Unit (MPDU) loss compared to the Extremely High Through (EHT) operation defined in IEEE P802.11 be.

R-TWT was one of the key features designed in Wi-Fi7 (IEEE 802.11 be) to prioritize low latency traffic within a protected service period (SP) for Restricted Target Wake Time (R-TWT) member STAs. In Wi-Fi 7, the EHT AP and its associated non-AP EHT STAs can negotiate an R-TWT SP to prioritize latency sensitive UpLink (UL) or DownLink (DL) traffic satisfying certain Transmission Identifiers (TIDs). An overlapping quiet interval commences at the starting point of the R-TWT SP, which is used for preventing legacy non-AP STAs, and some EHT non-AP STAs, from accessing the medium during this protective interval. The STAs that do not have R-TWT membership may not contend for channel access during the quiet interval. Thus, this mechanism reduces channel contention during the overlapping quiet interval. Since non-AP EHT STAs may ignore overlapping quiet intervals, the R-TWT schedule has an additional rule to terminate the TXOP of the TXOP holder, at the starting point of the R-TWT SP, to further prioritize channel access of R-TWT AP and the related R-TWT member STAs.

### 2. Problem Statement

Currently the R-TWT feature has been designed primarily for single BSS situations, and thus interference from an OBSS was not taken into full consideration. Interference from the OBSS may cause the medium to be busy during the scheduled R-TWT SP, which can result in delaying latency sensitive traffic.

An additional issue is that the OBSS TXOP can overlap the starting point of the R-TWT SP of the intended BSS. Furthermore, OBSS devices do not respect the overlapping quiet interval at the beginning of the R-TWT SP of the intended BSS. Even if all STAs of the intended BSS respect the R-TWT SP protection rules, it is still difficult for the R-TWT scheduling AP or the R-TWT member STAs of the intended BSS to obtain prioritized channel access due to the interference from the OBSS.

In this context, the Coordinated R-TWT (C-RTWT) schedule between adjacent BSSs should be configured in the next generation Wi-Fi 8 (802.11 bn) to prevent the OBSS from interfering with the R-TWT SP of the intended BSS. Toward that end new data structures, methods and rules for C-RTWT channel access are required for different types of devices and for different types of network topologies.

### 3. Objectives of the Present Disclosure

The present disclosure has a number of objectives for C-RTWT procedures, including but not limited to: (a) C-RTWT channel access mechanisms to prevent the OBSS from interfering with the R-TWT SP of the intended BSS; (b) resolution mechanisms based on different network topologies; (c) resolution mechanisms based on certain scenarios; (d) the use of a back-to-back CF-End transmission to truncate basic Network Allocation Vector (NAV) of OBSS; and (e) new channel access rules including TXOP termination, overlapping quiet interval and C-RTWT SP sharing for AP and non-AP STAs in BSS1 and BSS2, before, at and after the starting point of BSS2 R-TWT SP.

### 4. Communication Hardware Embodiments

### 4.1. Communication Station (STA and MLD) Hardware

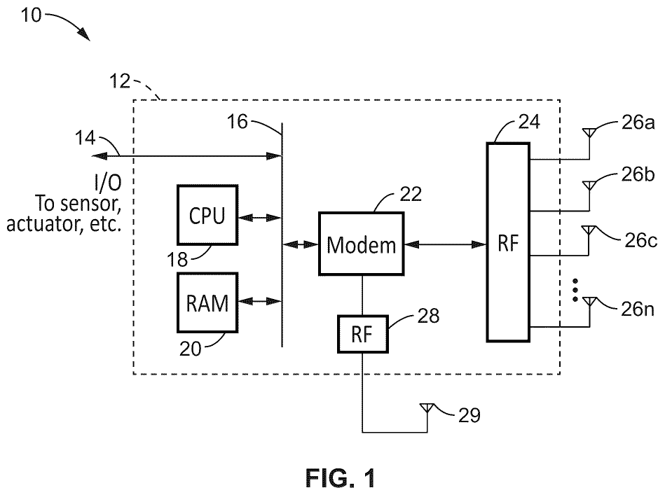

FIG. 1 illustrates an example embodiment 10 of STA hardware configured for executing the protocol of the present disclosure. An external 1/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an Access Point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

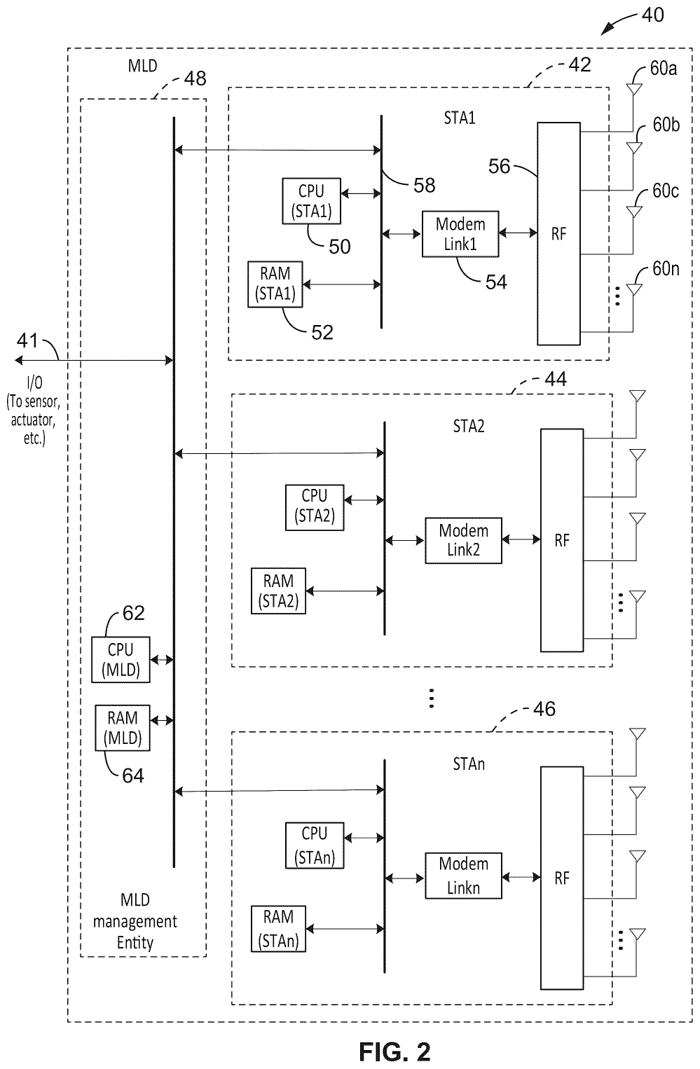

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 4.2. Backhaul Architecture for AP MLDs

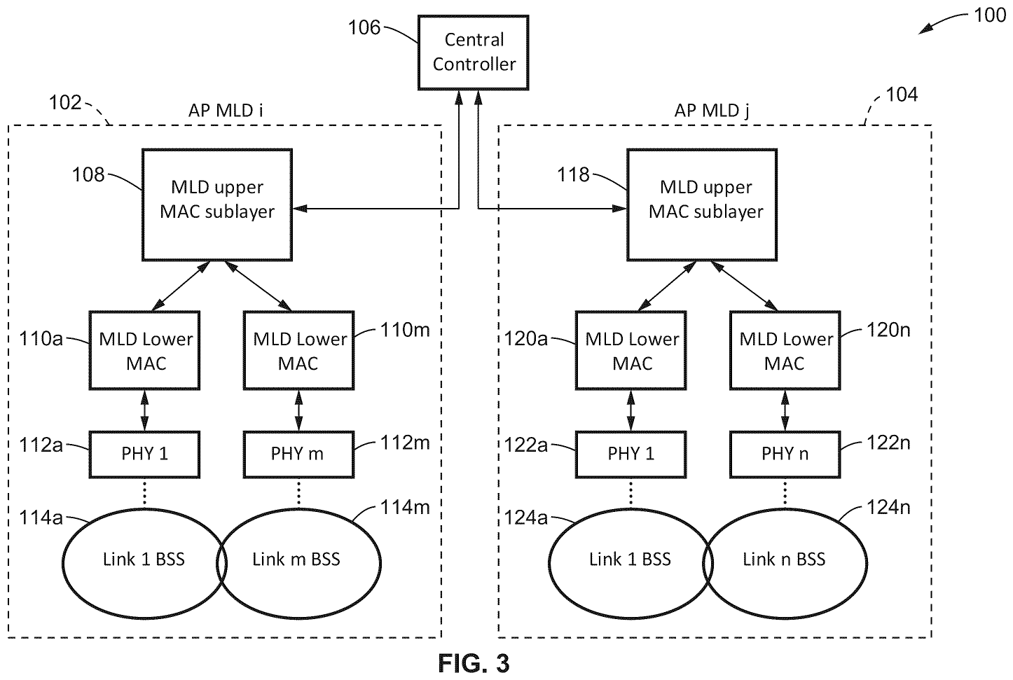

FIG. 3 illustrates an example embodiment 100 of a high level architecture for AP MLDs having multiple affiliated APs (e.g., 102, 104) connected to a central controller 106. The proposed enhancements provided in this disclosure may have a backhaul connected between cooperating APs. The backhaul architecture has one central controller connected with multiple AP MLDs through wired and/or wireless backhauls and each AP MLD 102, 104 includes the MLD upper MAC sublayer 108, 118, and one or more MLD lower MAC sublayers, one for each link 110a-110m, 120a-120n. In the 802.11 be specification, the MLD upper MAC sublayer performs functionalities that are common across all links, and each MLD lower MAC sublayer performs functions that are local to each link. For example, some link management related functions, such as TID-to-Link mapping and Link Merging are placed in the MLD upper MAC sublayer. In 802.11 bn, some functionalities originally in the MLD upper MAC sublayer as specified in 802.11 be may be suitably placed in the central controller, so as to be able to enhance seamless roaming with limited or no interruptions of service. The present disclosure considers link management functionalities placed in the central controller and/or the MLD upper MAC sublayers. It should be noted that the figure also depicts the connections to the Physical layer (PHY) 112a-112m, 122a-122n, and then down to the Link layers 114a-114m, 124a-124n.

### 5. Example Network Topologies

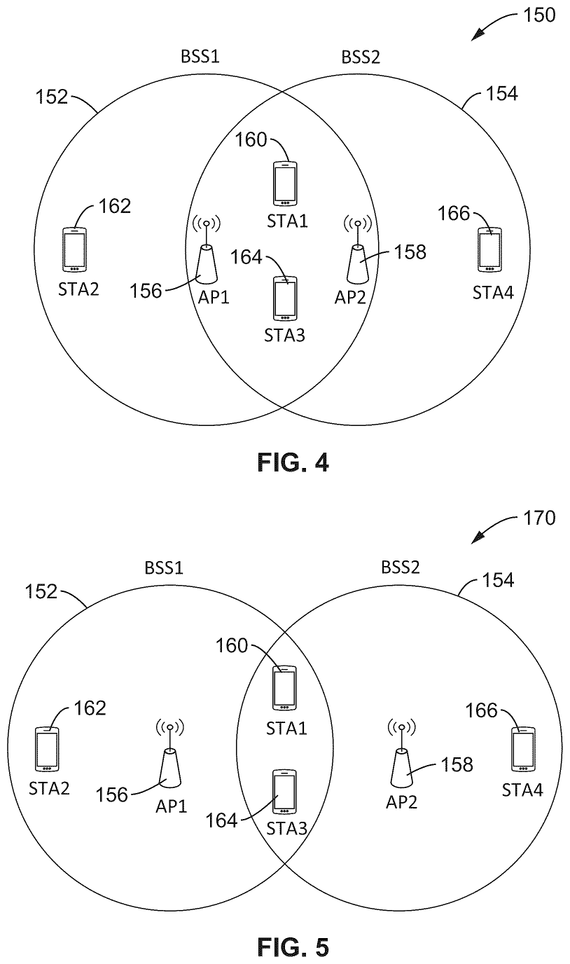

FIG. 4 and FIG. 5 illustrate examples of adjacent BSSs with non-interfering APs 150 in FIG. 4, and interfering APs 170 in FIG. 5.

The network topology shown in FIG. 4 is a representative topology which has two adjacent BSSs which are identified as BSS1 152 and BSS2 154. In BSS1, STA1 160 and STA2 162 are associated with AP1 156. In BSS2, STA3 164 and STA4 166 are associated with AP2 158. AP1 and AP2 are located within the communication range of each other, which may or may not have a wired/wireless backhaul connection between APs. STA1 and STA3 are located within the overlapped communication range of AP1 and AP2. STA2 and STA4 are only located within the communication range of their own associated APs and outside of the communication range of their adjacent BSS APs.

The network topology shown in FIG. 5 is another representative topology which has two 2 adjacent BSSs as in FIG. 4. In BSS1 152, STA1 160 and STA2 162 are associated with AP1 156. In BSS2 154, STA3 164 and STA4 166 are associated with AP2 158. AP1 and AP2 are located outside of the communication range of each other. STA1 and STA3 are located within the overlapped communication range of AP1 and AP2. STA2 and STA4 are only located within the communication range of their own associated APs and outside of the communication range of their adjacent BSS APs.

### 6. C-RTWT Embodiments

### 6.1. Definition of C-RTWT

C-RTWT is a coordinated mechanism that could be applied to adjacent BSSs. The C-RTWT mechanism can be combined with other multiple AP coordination mechanisms, such as Coordinated Time Division Multiple Access (C-TDMA), Coordinated Orthogonal Frequency Division Multiple Access (C-OFDMA) and Coordinated Spatial Reuse (C-SR). If not specifically indicated in this disclosure, in reference to C-RTWT it will be referred to in its application for C-TDMA procedure, however, it should be appreciated that at least a portion of the described embodiments can also apply to C-OFDMA and C-SR, or otherwise the extension of them for this purpose is within the skill of one of ordinary skill in the art.

The C-RTWT should be applied to interfering Service Periods (SPs), which occur when a TXOP holder or the transmission from a TXOP responder from one BSS interferes with the transmission, and/or reception, of R-TWT members and the R-TWT scheduling AP of an R-TWT SP from the adjacent BSS. The interfering SP can be a TXOP that may, or may not, be necessarily within an R-TWT SP. It should be noted that in this disclosure the term ‘interfering SP’ can refer to either an interfering TXOP or an interfering R-TWT SP.

The OBSS interference is determined by a receiver which detects or receives the inter-BSS frame and assesses that this is indeed an interference, and this assessment is based on determining if certain conditions are met, for example that certain measurements fall above or below a given threshold (e.g., Received Signal Strength Indicator (RSSI), Received Channel Power Indicator (RCPI), or Received Signal-to-Noise Indicator (RSNI).

The following example shows the case of non-interfering scenarios based on the network topology shown in FIG. 4 and/or FIG. 5.

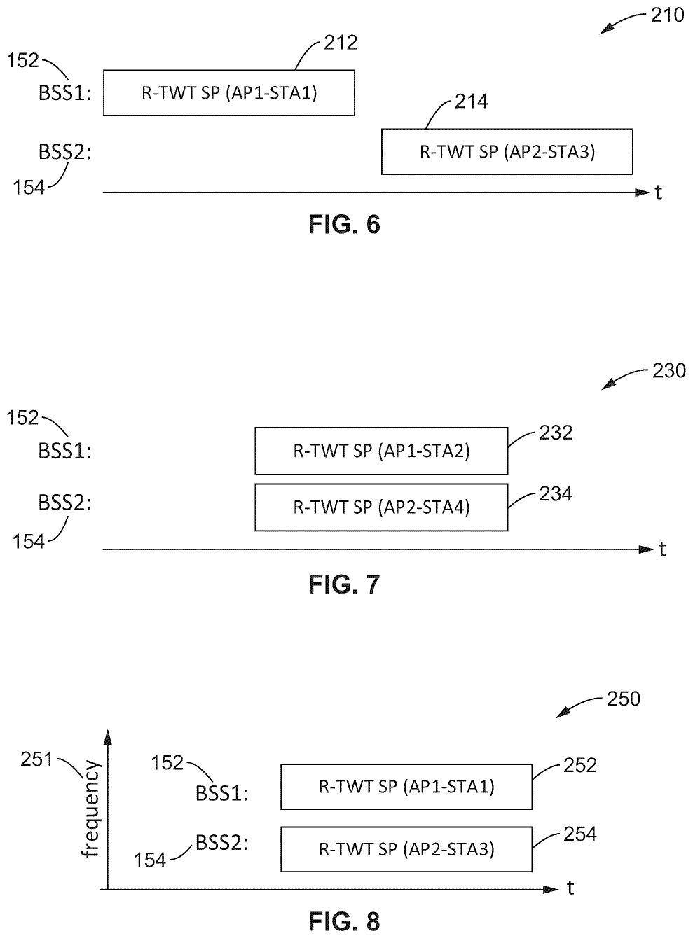

FIG. 6 illustrates a communication 210 of a time domain overlapped SPs of adjacent BSSs 152, 154 which are not subject to spatial interference. The R-TWT SP 212 granted to AP1 and STA1 in BSS1 is not overlapping in the time domain with the other R-TWT SP 214 granted to AP2 and STA3. In this case the two SPs are not interfering with one another regardless of whether they fall in the network topology shown in FIG. 4 or FIG. 5.

FIG. 7 illustrates a communication diagram 230 of time domain overlapped SPs of adjacent BSSs 152, 154 utilizing frequency division multiplexing. The R-TWT SP 232 granted to AP1 and STA2 in BSS1 is overlapping in the time domain with the other R-TWT SP 234 granted to AP2 and STA4. The two SPs are interfering SPs based on the example network topology shown in FIG. 4 since AP1 and AP2 are interfering with each other, while the two SPs are non-interfering SPs, based on the network topology shown in FIG. 5, since in this case both APs and STAs are out of range between each other.

FIG. 8 illustrates a communication diagram 250 of time domain overlapped SPs of adjacent BSSs 152, 154, with frequency division multiplexing. The R-TWT SP 252 granted to AP1 and STA1 in BSS1 is overlapping in time domain with the other R-TWT SP 254 granted to AP2 and STA3. Due to the use of frequency division multiplexing, such as by applying an C-OFDMA mechanism, the two SPs are divided to use different frequencies and not interfering with each other. In this case, the two SPs are non-interfering SPs in both the representative network topologies shown in FIG. 4 and FIG. 5.

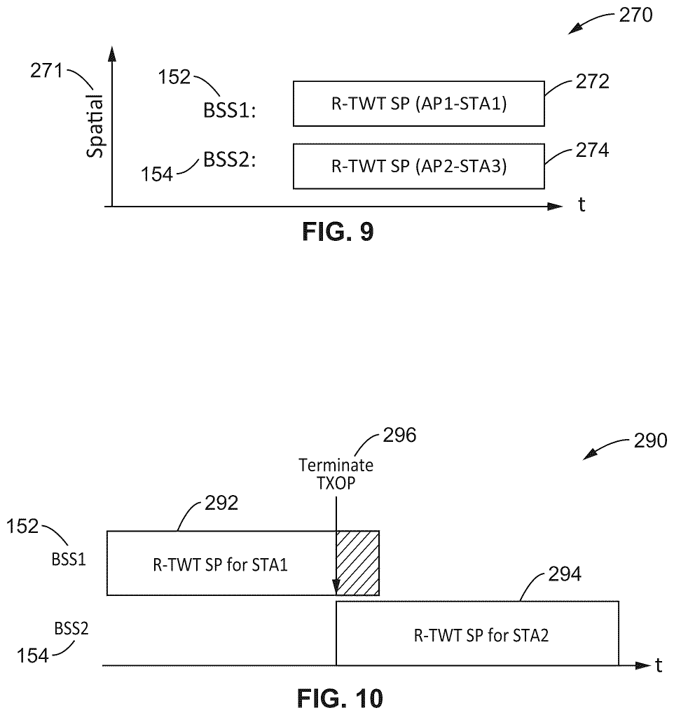

FIG. 9 illustrates a communication diagram 270 of time domain overlapped SPs of adjacent BSSs 152, 154 with spatial division. The R-TWT SP 272 granted to AP1 and STA1 in BSS1 is overlapping in the time domain with the other R-TWT SP 274 granted to AP2 and STA3 in BSS2. Due to the spatial division, such as by applying a C-SR mechanism, the two SPs use different spatial resources and thus would not be interfering with each other. In this case, the two SPs are non-interfering SPs in both the representative network topologies shown in FIG. 4 and FIG. 5.

### 6.2. Basic NAV Truncation

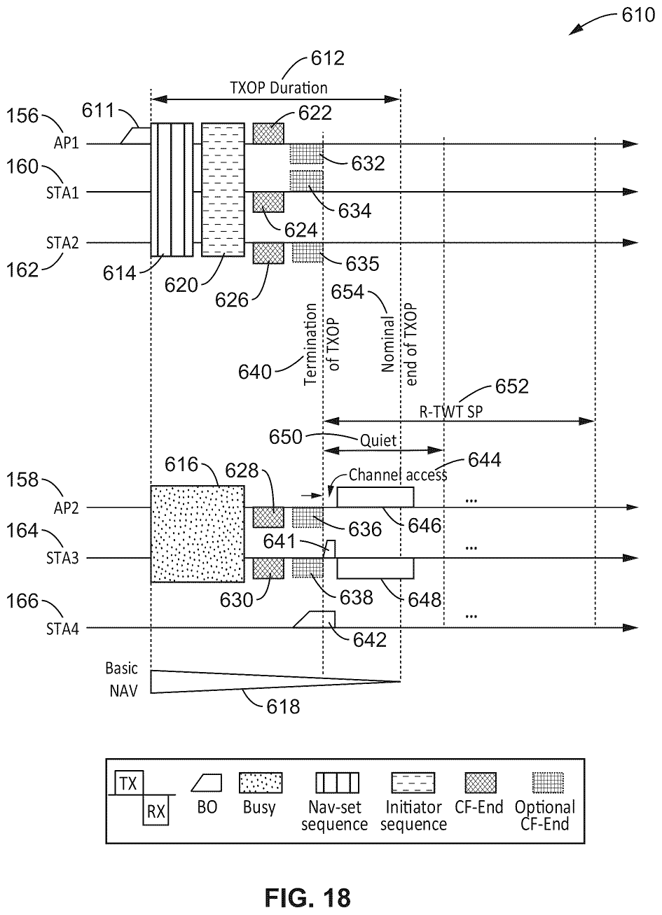

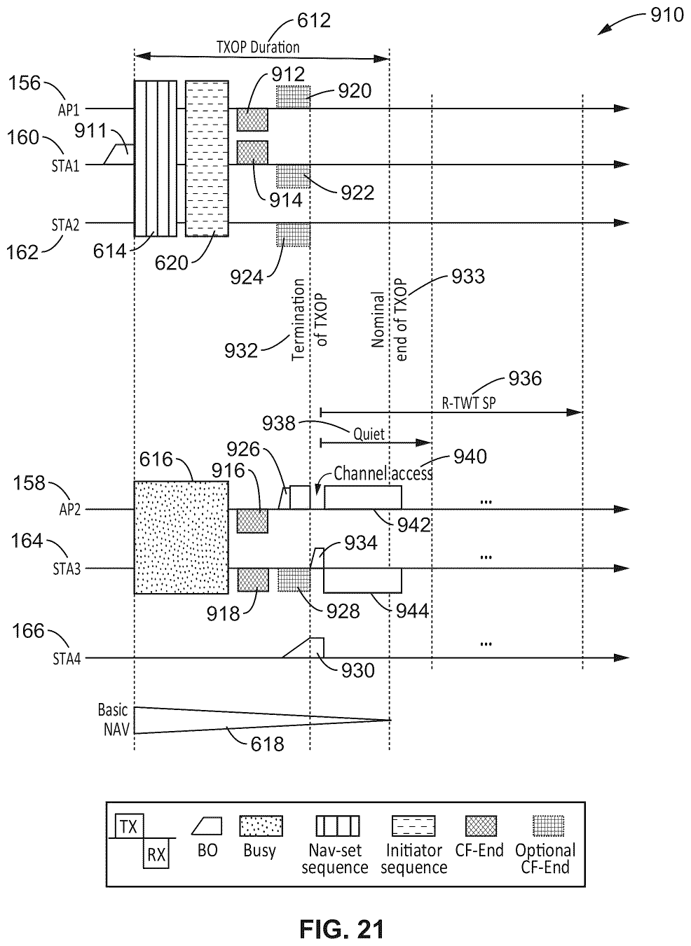

When terminating an OBSS TXOP the basic NAV needs to be reset at the starting point of the R-TWT SP. The hidden terminal issue should be addressed in performing CR-TWT NAV truncation. When the TXOP holder from BSS1 interferes with AP2 from BSS2 and the TXOP responders from BSS1 do not interfere with the AP2 from BSS2, the TXOP holder shall broadcast a CF-End frame to clear the basic NAV for AP2 and/or STAs from BSS2. The TXOP responder may optionally broadcast CF-End frame to clear the basic NAV for the AP2 and/or STAs from BSS2. The corresponding examples and illustrations are provided in FIG. 18 and in FIG. 21.

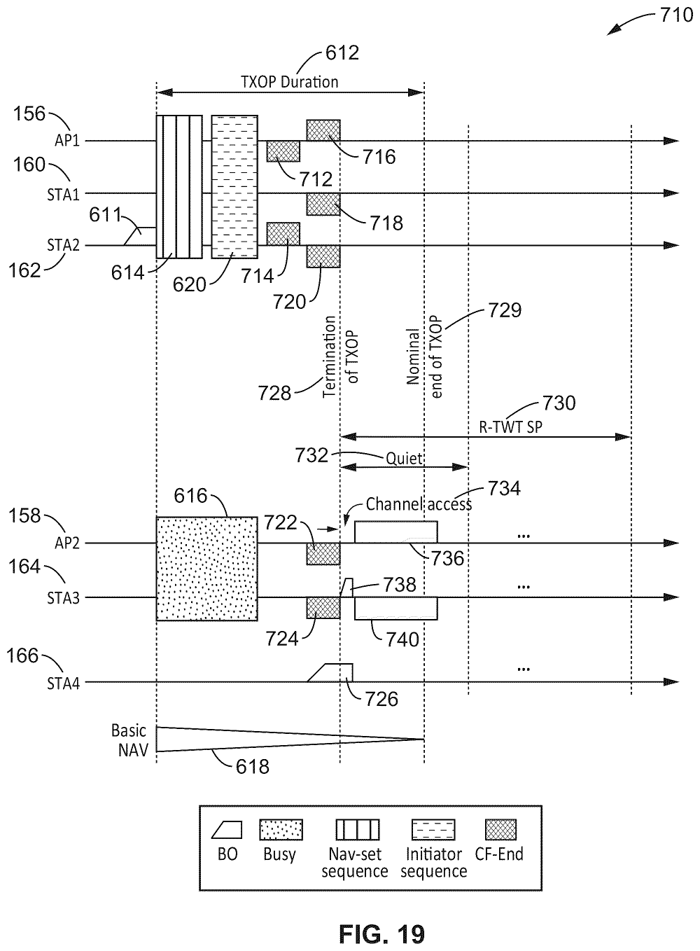

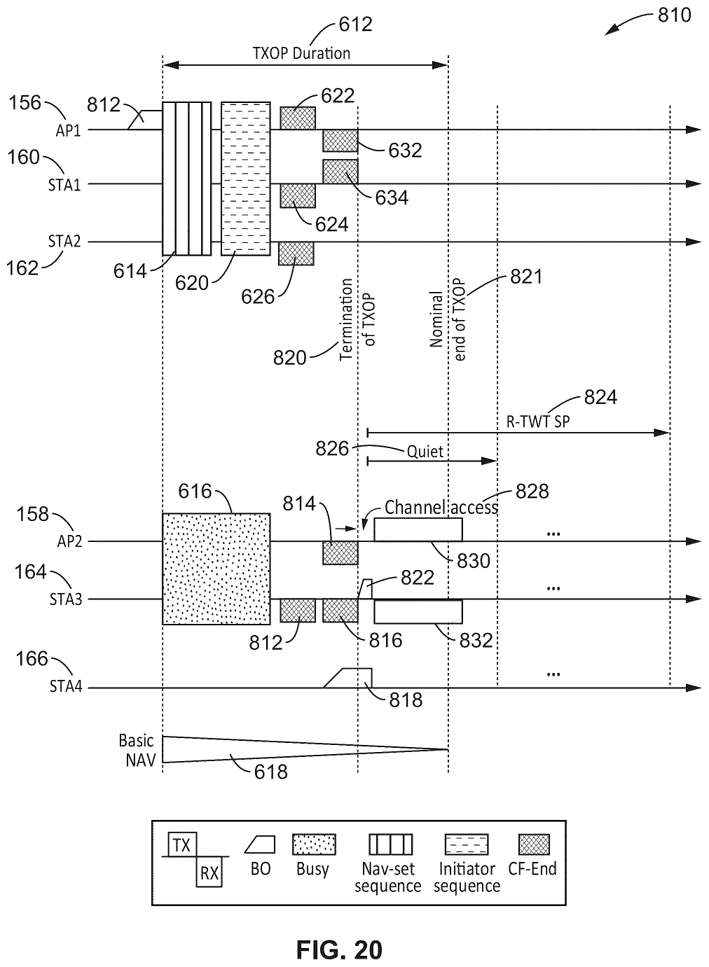

When the TXOP holder from BSS1 does not interfere with the AP2 from BSS2, and yet the TXOP responders from BSS1 interfere with the AP2 from BSS2, the TXOP holder and the TXOP responder from BSS1 should broadcast CF-End frames in a back-to-back manner to clear the basic NAV for AP2 and/or STAs from BSS2. The corresponding examples and illustrations are provided in FIG. 19 and FIG. 20.

FIG. 10 through FIG. 13 illustrate simple example scenarios of NAV truncation requirements.

In FIG. 10 communications 290 are shown with BSS1 152 with R-TWT SP 292 for STA1 and BSS2 154 with R-TWT SP 294 for STA2, and is shown with a termination 296 of the TXOP. It should be appreciated that these figures are provided by way of example to simplify understanding of operations and not of limitation.

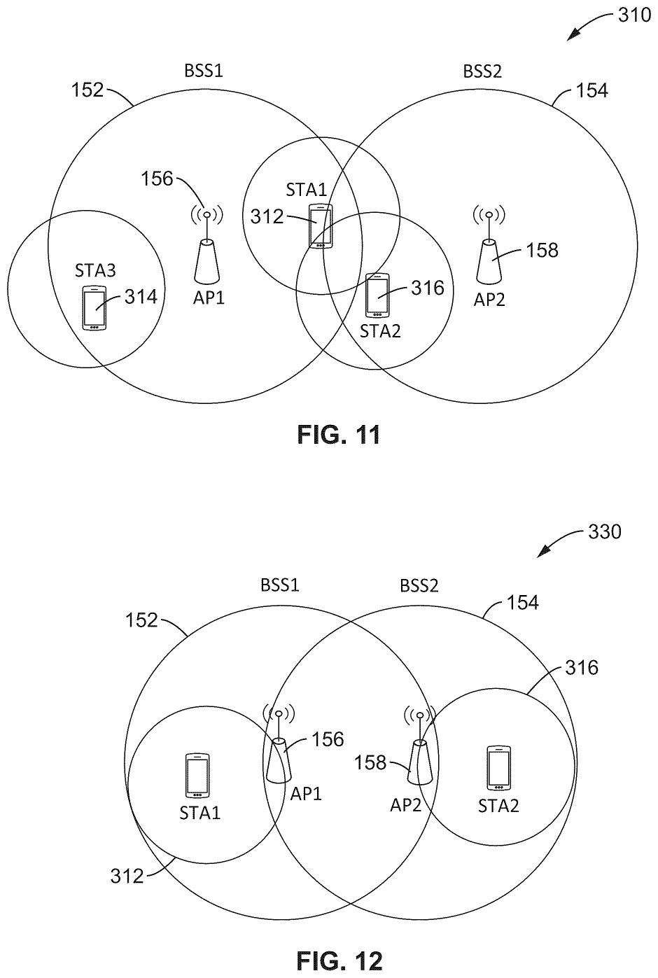

In FIG. 11 a topology 310 is shown of a TXOP holder for BSS1 152 as AP1 156 in a trigger-based R-TWT SP (Case 1.a), shown with STA1 312 and STA3 314 within BSS1 152 of AP1, while STA2 316 is in BSS2 154 having AP2 158. AP1 and AP2 are not in range of each other, and STA3 is not in direct communication range of AP2; however, STA1 and STA2 are each in range of both AP1 and AP2.

In FIG. 12 a topology 330 is shown of a TXOP holder as STA1 312 in a non-Trigger-enabled R-TWT SP in (Case 1.b), shown with STA1 312 in BSS1 152 of AP1 156, while STA2 316 is in BSS2 154 of AP2 158. The BSSs in this example overlap one another, such that AP1 and AP2 are just within communication range, while STA1 is not within range of AP2, nor is STA2 within the range of AP1.

In the examples, the TXOP is terminated 296 as seen in FIG. 10 and the NAV cleared at the starting point of the OBSS R-TWT SP, which could not be heard by the OBSS AP nor the OBSS R-TWT member STAs. In certain situations, such as with STA1 in trigger-based R-TWT SP in (Case 1.a), or AP1 in non-Trigger-enabled R-TWT SP in (Case 1.b), that is interfering with the AP and/or the R-TWT member STAs in BSS2, the TXOP responder may be required to clear the basic NAV in BSS2.

The TXOP holder, which is STA1 in a non-Trigger-enabled R-TWT SP in (Case 1.a) or AP1 in Trigger-enabled R-TWT SP in (Case 1.b), terminates the TXOP and clears the NAV at the starting point of the OBSS R-TWT SP, which can be recognized by the OBSS AP and/or R-TWT member STAs. This may still require that the TXOP responder, such as AP1 in non-Trigger-enabled R-TWT SP in (Case 1.a), clears the intra-BSS NAV in BSS1.

### 6.3. Protection of Overlapping Quiet Intervals of OBSS R-TWT SP

The R-TWT scheduling AP, R-TWT member STA(s) and non-R-TWT member STA(s) from BSS1 may have different capabilities and related behaviors to support the protection level of the overlapping quiet interval of the R-TWT SP from BSS2, which could be classified based on the following capabilities: (a) not respecting the OBSS R-TWT SP quiet interval, which indicates that the device may start contending for the channel at the starting point of the OBSS R-TWT SP; (b) not contending for channel access during the overlapping quite interval of the OBSS R-TWT SP, yet can resume channel contention after the overlapping quiet interval in the remaining portion of the OBSS R-TWT SP; (c) not contending during the entire length of the OBSS R-TWT SP, and thus the device does not contend for channel access during the entire OBSS R-TWT SP interval and shall resume channel contention after the OBSS R-TWT SP has been completed or truncated; and (d) the non-AP STA(s) may be legacy STA(s) that recognize and understand the quiet interval of the coordinated BSSs.

It should be noted that the non-AP STA(s) performing TXOP termination (truncation) should support the R-TWT operation and/or the C-RTWT operation.

A device could support one of the aforementioned capabilities or it could support all of them, and apply one of them based on the comparison between the Buffered Units (BUs) priority and the OBSS R-TWT Transmission ID (TID). In this context, the following embodiments can be applied to the device: (a) when the BU priority is significantly higher than the OBSS R-TWT TID, then the device may not respect the OBSS R-TWT SP quiet interval; (b) when the BU priority is higher than, or equal to, the OBSS R-TWT TID, the device may or may not respect the OBSS R-TWT quiet interval; (c) when the BU priority is lower than the OBSS R-TWT TID, the device should at least respect the OBSS R-TWT quiet interval; (d) when the BU priority is significantly lower than the OBSS R-TWT TID, the device shall respect the OBSS R-TWT quiet interval and may not contend during any portion of the OBSS R-TWT SP.

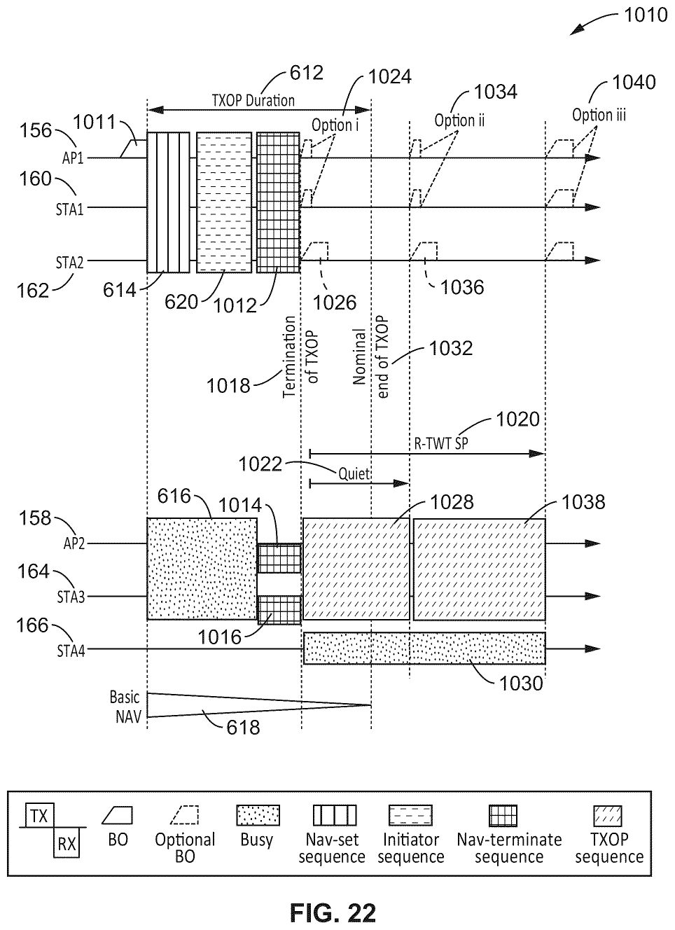

A set of metrics is outlined herein to assist these priority comparisons. For example, α, β and γ are used as the measures, in which α<β<γ. If the comparison values x and y, where xϵα and yϵβ, or xϵβ and yϵγ, then y could be considered higher than x, and x could be considered lower than y. If the comparison values x and y, where xϵα and yϵγ, then y could be considered significantly higher than x, and x could be considered as significantly lower than y. The granularity of the metrics set α, β and γ could be set as z, where z is an integer from 1 to 5. The corresponding example and illustration of this embodiment is provided in FIG. 22.

6.4. Channel Access Rules when BSS1 TXOP Interferes with BSS2 R-TWT SP

### 6.4.1. At the Starting Point of OBSS R-TWT SP

The termination of TXOP in BSS1 at the starting point of R-TWT SP from BSS2 should be determined based on C-RTWT negotiation. The Ultra High Reliability (UHR) devices from BSS1 can have different capabilities or behaviors to support the protection of TXOP termination at the starting point of the R-TWT SP from BSS2, which could be classified as the following capabilities:

The EDCA-based scenario, without explicit allocation of the TXOP for each BSS, has the following conditions: (a) only the AP from BSS1 can end the TXOP at the starting point of the R-TWT SP of BSS2; (b) only a STA from BSS1 can end the TXOP with respect to the starting point of the R-TWT SP from BSS2; (c) the AP and all its associated STAs from BSS1 end their TXOP at the starting point of the R-TWT SP of BSS2; (d) the AP, and at least a portion of its associated STAs from BSS1, end their TXOP at the starting point of the R-TWT SP of BSS2; (d)(i) the portion of the AP's associated STAs from BSS1 can be R-TWT member STAs which support C-RTWT features.

If an AP extends the protection of the R-TWT schedule of another AP, following negotiation or through other means, then: (a) the AP shall ensure its TXOP ends before the starting time of the corresponding OBSS R-TWT SP(s); (b) the AP, if it has at least one associated STA that is capable of performing R-TWT, shall advertise in the beacon frames that it transmits, an OBSS R-TWT schedule so that its associated STAs supporting R-TWT follow the baseline R-TWT rules for the OBSS R-TWT schedule.

In the schedule-based with explicit allocation of TXOP for each BSS, the scenario is as follows: (a) neither the AP nor its associated STAs should end their TXOP before the starting point of the OBSS R-TWT SP. This could be applied to the C-OFDMA and C-SR case, which will not be further discussed in this disclosure; (b) the non-AP STA(s) performing the TXOP termination should support the coordinated R-TWT operation; (c) the non-AP STA(s) performing the TXOP termination should support the R-TWT operation.

### 6.4.2. After the Starting Point of the OBSS R-TWT SP

For devices in BSS1 that do not interfere with the R-TWT SP from BSS2, the devices can utilize regular EDCA-based channel access; the corresponding example is shown in FIG. 20.

For devices in BSS1 that interfere with the R-TWT SP from BSS2, different channel access options can be applied depending on device capability to support protection of the overlapping quiet interval of the R-TWT SP from BSS2, based on the embodiments disclosed in section 6.3. The corresponding examples and illustrations are provided in FIG. 22.

In at least one embodiment, channel access rules are defined for AP2 from BSS2. If AP2 detects CCA idle at the starting point of the R-TWT SP in BSS2, then AP2 from BSS2 can process one of following channel accesses: (a) immediate channel access at the starting point of the R-TWT SP of BSS2; (b) immediate channel access of an IFS, which could be SIFS, PIFS, or similar, after the starting point of the R-TWT SP of BSS2; (c) immediate starting of a BackOff (BO) at the starting point of the R-TWT SP of BSS2. It should be noted that the corresponding examples can refer to Section 9.1.

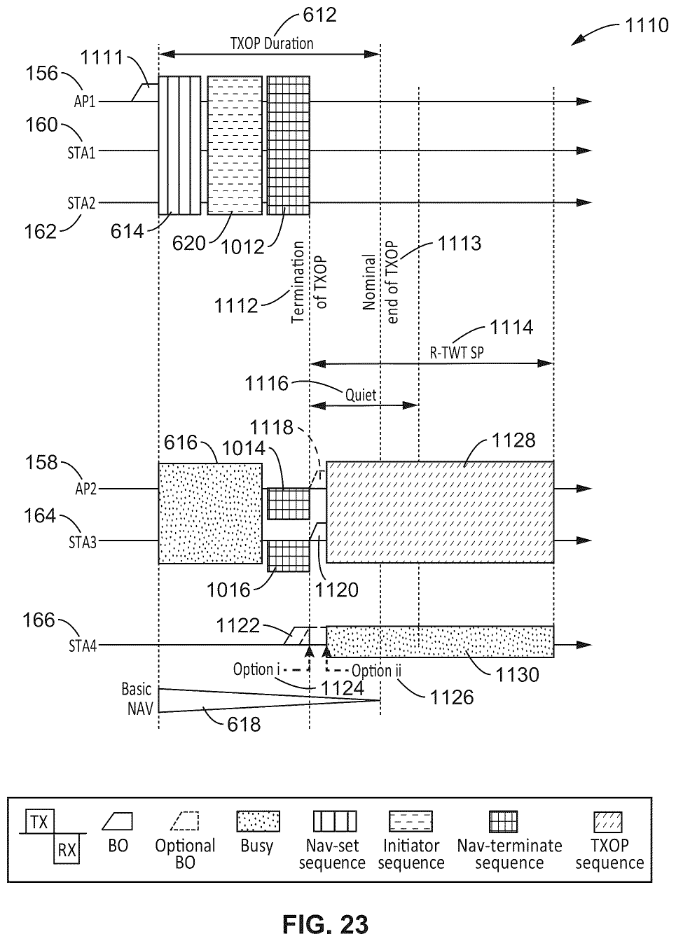

In at least one embodiment, channel access rules are defined for AP2 from BSS2. If AP2 detects CCA idle for a certain time threshold, before the starting point of the R-TWT SP of BSS2, then AP2 from BSS2 can process one of following channel access rules: (a) starting EDCA-based channel access before the starting point of the R-TWT SP of BSS2; (b) AP2 may continue the TXOP at the starting point of the R-TWT SP of BSS2 if the transmitted or received PPDUs in the current TXOP satisfy the R-TWT DL or UL TID limitation in the R-TWT SP of BSS2; (c) AP2 may continue the TXOP at the starting point of the R-TWT SP of BSS2, if AP2 is in the process of transmitting Beacon frames; (d) AP2 may terminate the TXOP at the starting point of the R-TWT SP of BSS2 if the transmitted or received PPDUs in the current TXOP do not satisfy the R-TWT DL or UL TID limitation in the R-TWT SP of BSS2; in this case, AP2 from BSS2 should perform CCA sensing at the starting point of the R-TWT SP of BSS2. It should be noted that the corresponding examples generally refer to FIG. 23.

In at least one embodiment, for non-AP STAs from BSS2, the following channel access rules should be applied: (a) EDCA-based channel access is always required (needed) prior to accessing the channel; (b) the non-AP STAs from BSS2 should terminate the TXOP at the starting point of the R-TWT SP of BSS2 following the 802.11 be R-TWT rules. It should be noted that the corresponding example generally refers to FIG. 23.

6.5. Channel Access Rules when BSS1 R-TWT SP Interferes with BSS2 R-TWT SP

### 6.5.1. At the Starting Point of the OBSS R-TWT SP

For this specific case, the termination rules of TXOP in BSS1 R-TWT SP disclosed in Section 6.4.1 could also be applied in this situation. In addition to those termination rules, the following additional capabilities could be additionally included.

In the EDCA-based case, without explicit allocations of the TXOP for each BSS, the scenario is as follows. (a) The R-TWT scheduling AP and R-TWT schedule a STA from BSS1 to continue the TXOP within the R-TWT SP of BSS1, and it passes the starting point of the R-TWT SP of BSS2; with the corresponding examples and illustrations provided in Section 9.3.1. (b) The R-TWT scheduling AP and R-TWT scheduled STA from BSS1 terminates the TXOP within the R-TWT SP of BSS1 within a certain (specified) time period before the starting point of the R-TWT SP of BSS2. The corresponding examples and illustrations are provided in Section 9.3.2. (c) The R-TWT scheduling AP and R-TWT scheduled STA from BSS1 terminates the TXOP within the R-TWT SP of BSS1 at the starting point of the R-TWT SP of BSS2. The corresponding examples and illustrations are provided in Section 9.3.3.

When the R-TWT scheduling AP and R-TWT scheduled STA from BSS1 terminates the TXOP to share channel access with the R-TWT scheduling AP and R-TWT scheduled STA from BSS2, with several embodiments disclosed in the following to enable channel access of R-TWT members from BSS2.

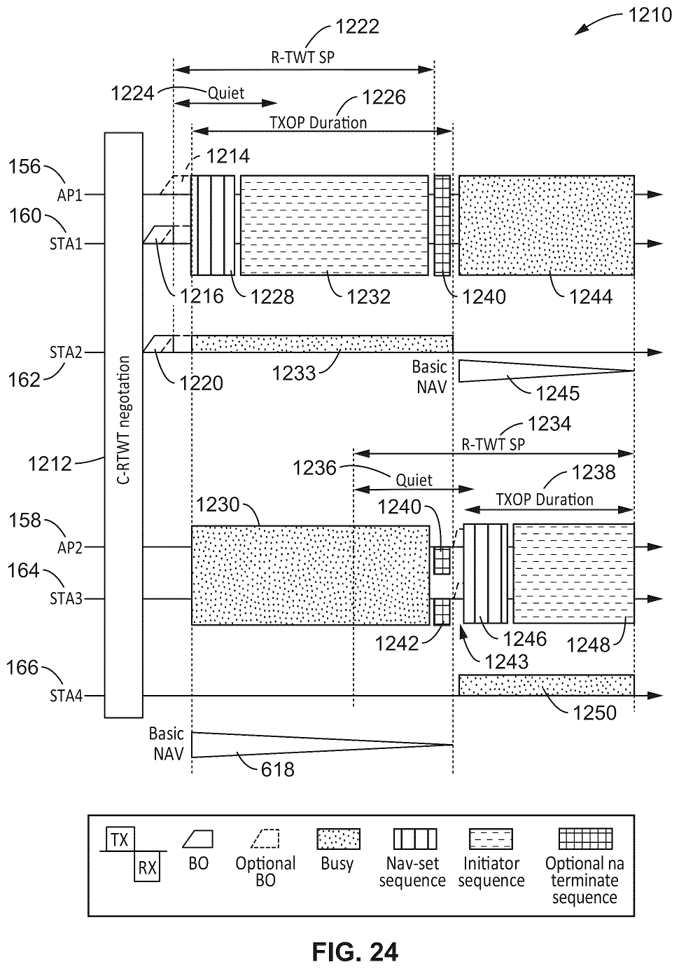

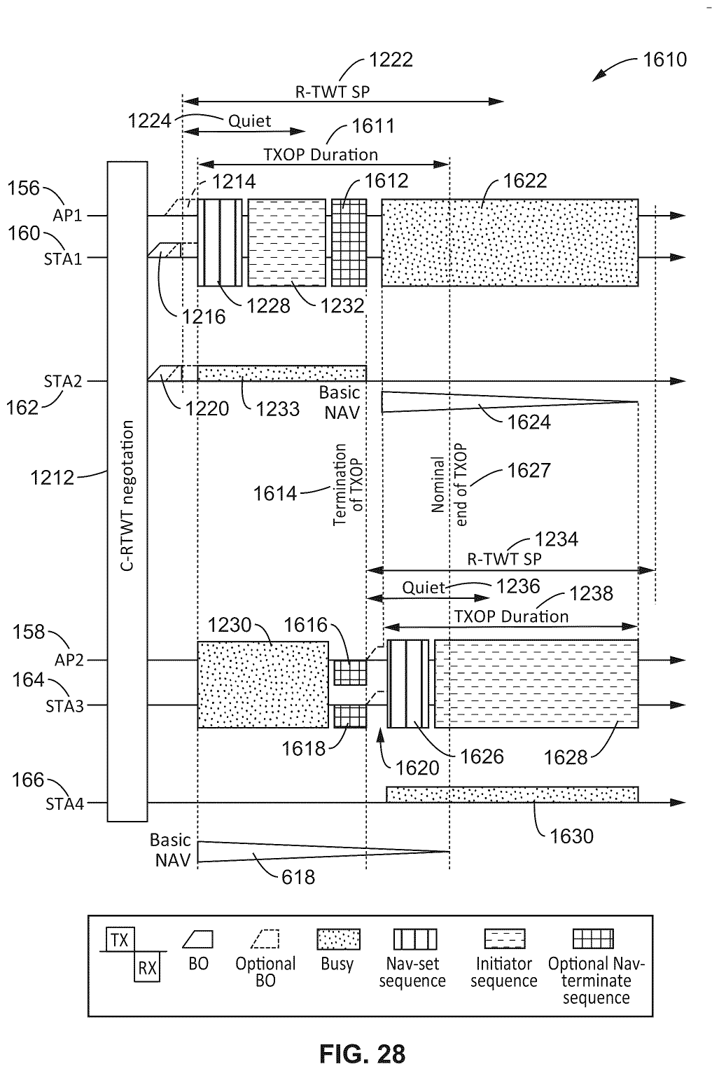

(a) In at least one embodiment, the R-TWT scheduling AP and R-TWT scheduled STA from BSS1 transmits an optional NAV-terminate sequence, such as using a back-to-back CF-End or other PPDUs capable of clearing the basic NAV in BSS2. The corresponding example and illustrations are provided in FIG. 24 and FIG. 28.

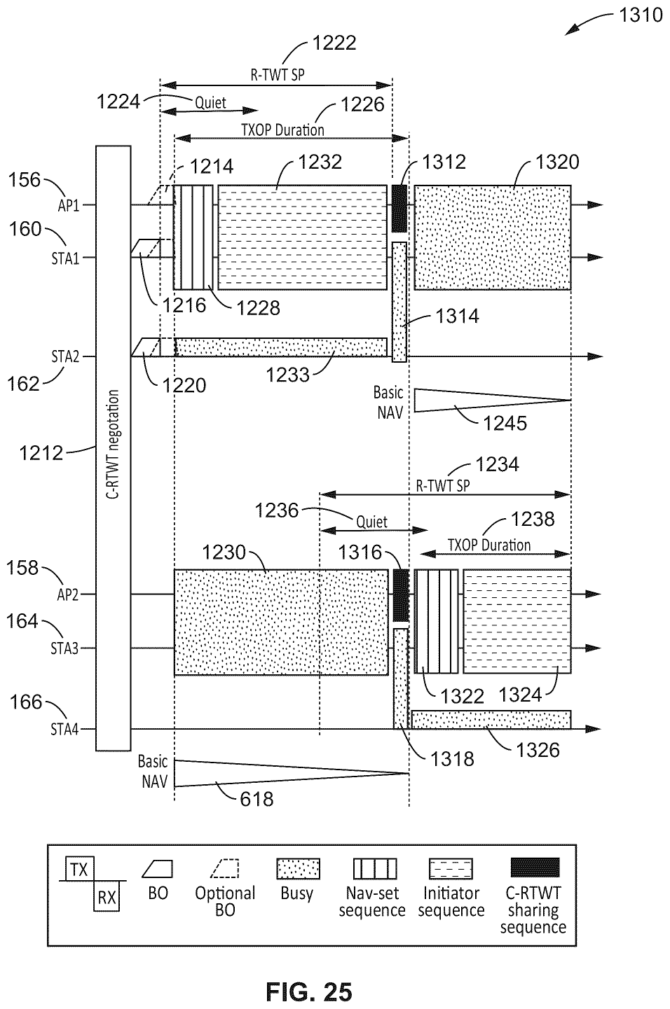

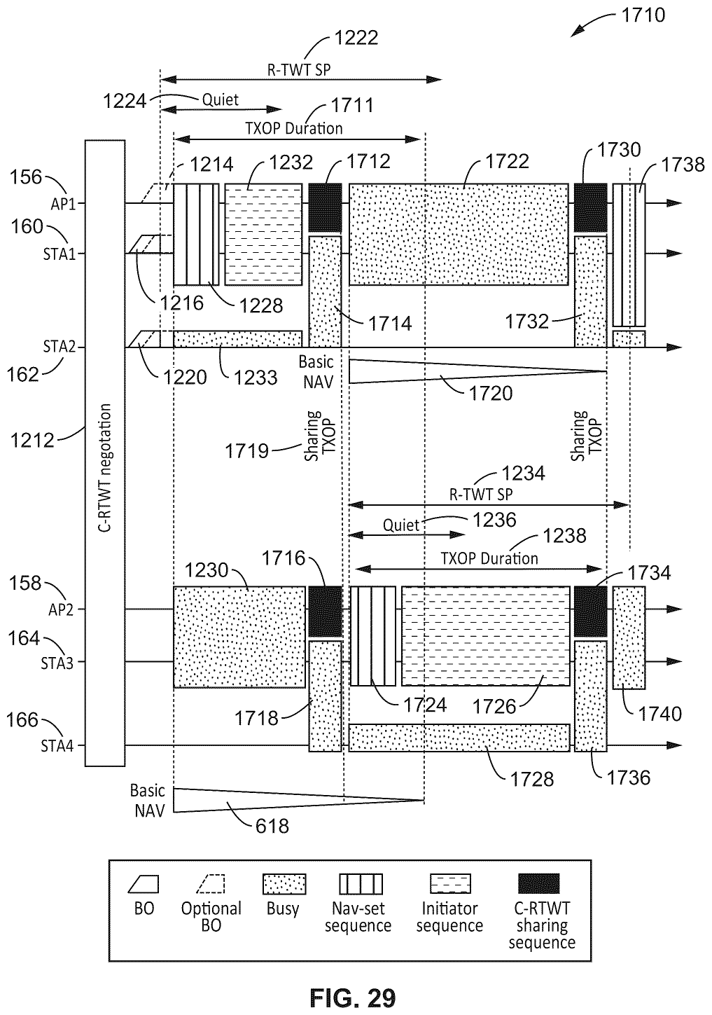

(b) The R-TWT scheduling AP from BSS1 directly exchanges a C-RTWT sharing or negotiation sequence with the R-TWT scheduling AP from BSS2 to hand over (surrender) channel access to, or to negotiate, a C-RTWT schedule with the R-TWT scheduling AP from BSS2. The R-TWT scheduling AP from BSS2 should ignore the basic NAV and can signal the R-TWT scheduled STAs from BSS2 to ignore the basic NAV. The R-TWT scheduled STAs from BSS2 can also clear the basic NAV in response to overhearing the C-RTWT sharing sequence. The corresponding example and illustrations are provided in FIG. 25 and FIG. 29.

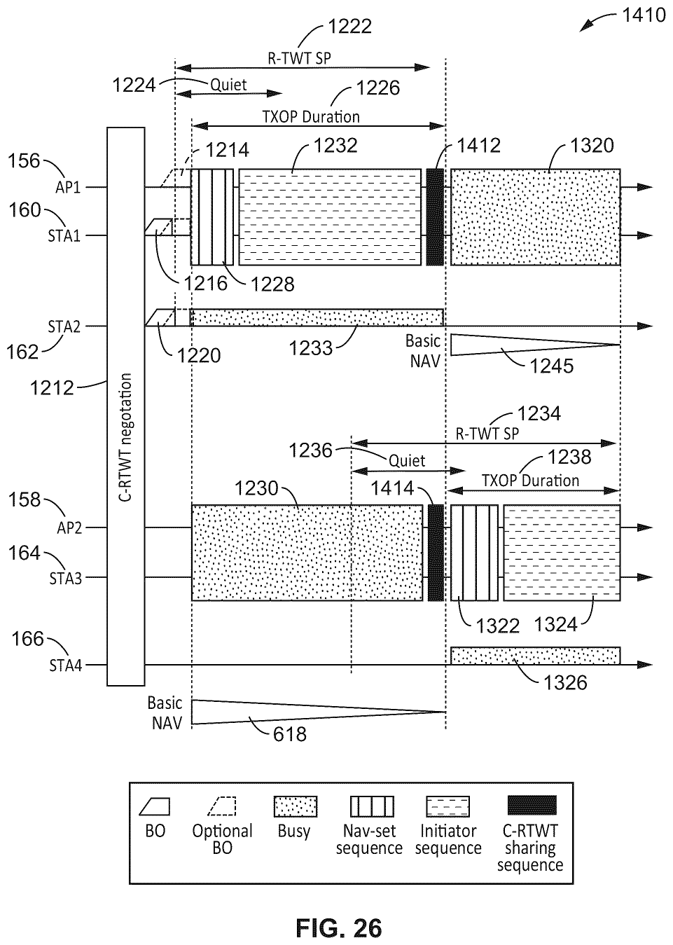

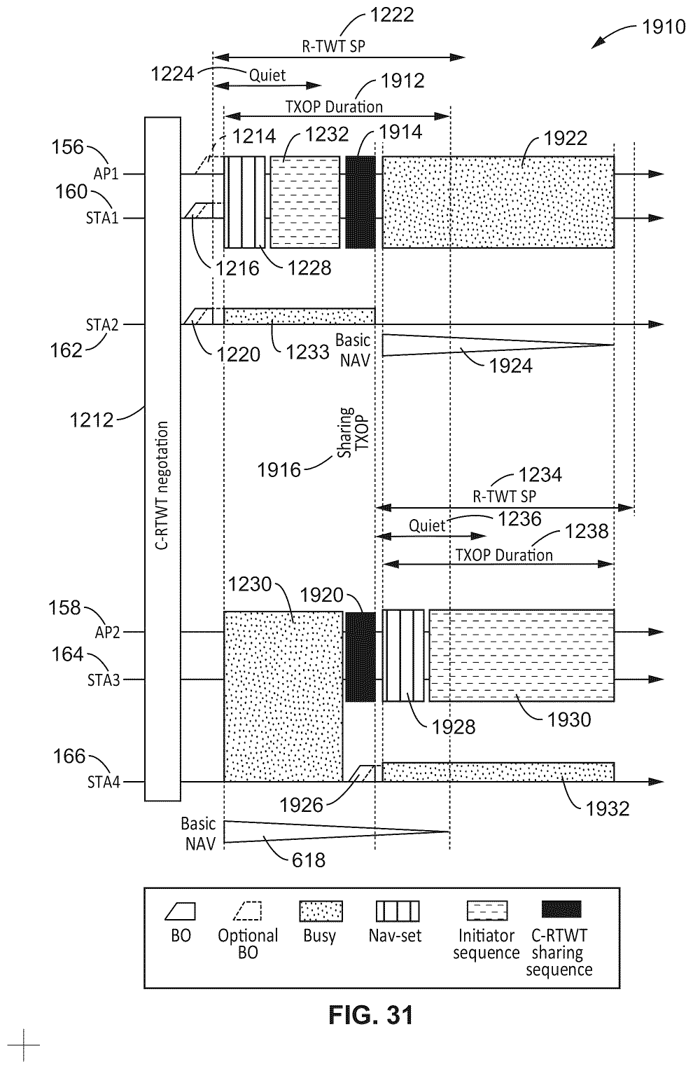

(c) The R-TWT scheduling AP from BSS1 exchanges a C-RTWT sharing or negotiation sequence with the R-TWT scheduling AP from BSS2 through the relay of non-AP STA(s) to handover (surrender) channel access to, or to negotiate, a C-RTWT schedule with the R-TWT scheduling AP from BSS2. The R-TWT scheduling AP from BSS2 should ignore the basic NAV and can signal the R-TWT scheduled STAs from BSS2 to ignore the basic NAV. The R-TWT scheduled STAs from BSS2 can also clear the basic NAV in response to overhearing (receiving) the C-RTWT sharing/negotiation sequence. The corresponding example and illustrations are provided in FIG. 26 and FIG. 31.

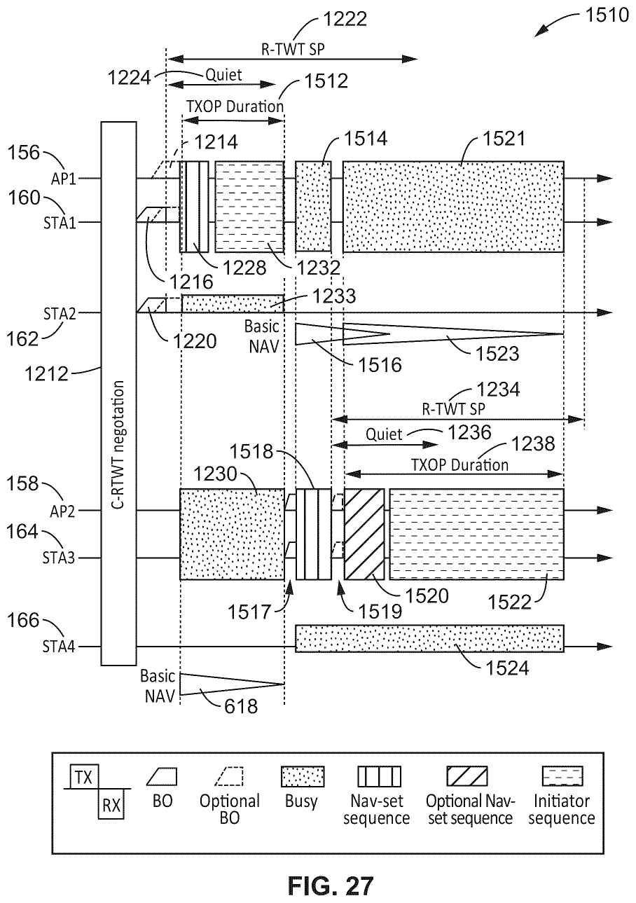

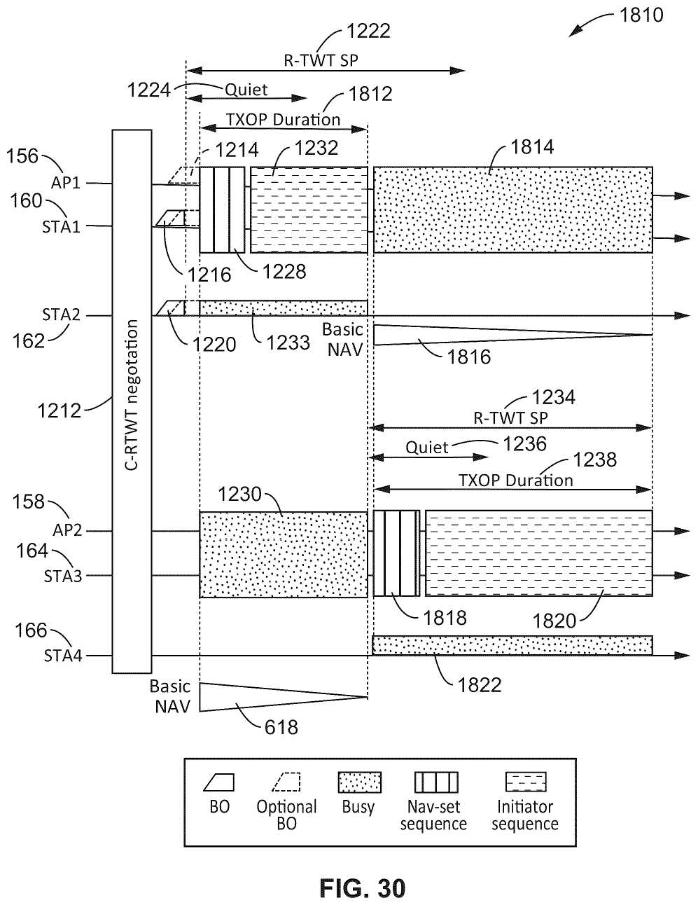

(d) The R-TWT scheduling AP and R-TWT scheduled STAs from BSS1 refrain from transmitting anything to indicate the handover (surrender) of channel access to R-TWT members from BSS2. The basic NAV in BSS2 expires before, or at the starting point, of the BSS2 R-TWT SP. The corresponding example and illustrations are provided in FIG. 27 and FIG. 30.

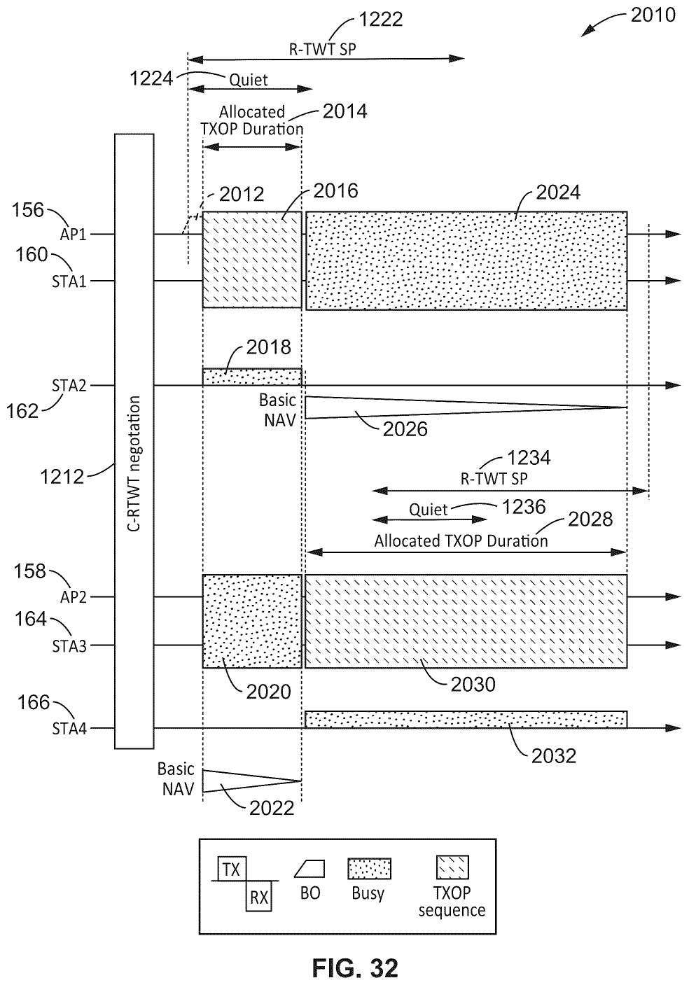

In the schedule-based scenario with explicit allocation of TXOP for each BSS, the following conditions apply: (a) the AP and STA in each BSS should respect the C-RTWT negotiated schedules to start and finish the TXOP; (b) the sharing and shared SP duration and SP distribution of the coordinated BSSs should be determined during the C-RTWT negotiation, or follow a predetermined scheduling rule; (c) R-TWT TIDs should be considered in the C-RTWT SP schedule. The corresponding example and illustrations are provided in FIG. 32.

### 6.5.2. After the Starting Point of OBSS R-TWT SP

Once the R-TWT scheduling AP and R-TWT scheduled STA from BSS1 terminate the TXOP and handover (surrender) channel access to the R-TWT scheduling AP and the R-TWT scheduled STA from BSS2, then AP2 from BSS2 can follow one of the following ways to access the channel once it detects CCA idle: (a) immediately access the channel at the starting point of the R-TWT SP; (b) immediate access the channel at the IFS slot boundary, which could be SIFS, PIFS, or similar, after the starting point of the R-TWT SP; or (c) immediately start a BO at the starting point of the R-TWT SP.

The non-AP STAs of BSS2 should process EDCA-based channel access and follow the R-TWT channel access rule in 802.11 be specification. The corresponding example and illustration are provided in Section 9.3.1.

### 6.6. OBSS Interference Impact on CR-TWT Enhanced Channel Access

The CR-TWT enhanced channel access methods/rules should be designed with awareness of the actual network topology and OBSS interference level at both AP and/or non-AP STA side.

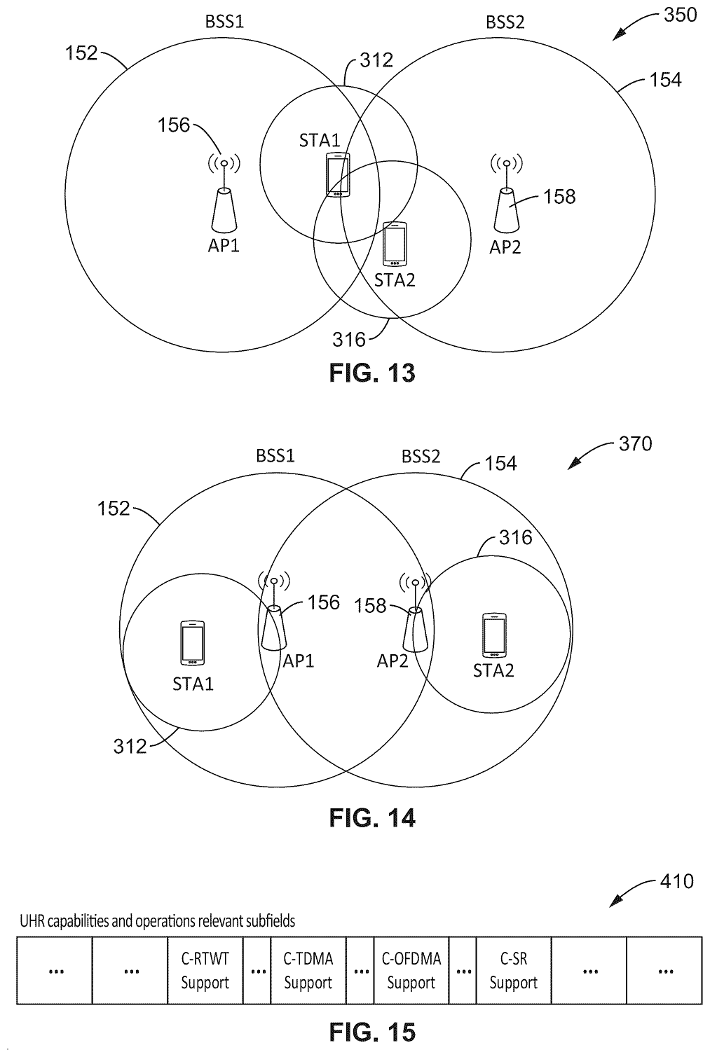

FIG. 13 and FIG. 14 illustrate 350, 370 two cases of OBBS interference impact on CR-TWT Enhanced Channel Access. BSS1 152 and BSS2 154 are shown with AP1 156, AP2 158, STA1 312, and STA2 316.

In FIG. 13 the R-TWT scheduling AP (e.g., AP1) does not interfere with OBSS AP nor does it interfere with the OBSS R-TWT member STAs. The AP does not need to apply the CR-TWT enhanced channel access rules; however, it is not allowed to solicit a UL transmission from its associated STA(s) that are interfering the AP and/or the R-TWT member STAs from OBSS.

In FIG. 14 the R-TWT scheduling AP (e.g., AP1) that is receiving interference from the AP and/or the R-TWT member STAs from the OBSS. The AP needs to apply the CR-TWT enhanced channel access rules; and it is not allowed to respond to the UL transmission from its associated STA(s) that are not interfering with the OBSS AP or the OBSS R-TWT member STAs.

In both cases (FIG. 13 and FIG. 14) the associated STA(s) may or may not necessarily be R-TWT supporting STA(s). For the R-TWT member STA (e.g., STA1) in FIG. 13 that is interfering with the OBSS AP and/or OBSS R-TWT member STAs: (a) it needs to apply the CR-TWT enhanced channel access rules; and (b) it is not to respond to the DL transmission from its associated AP that is not interfering with the OBSS AP or with OBSS R-TWT member STAs. For the R-TWT member STA (e.g., STA1) in FIG. 14 that does not interfere with OBSS AP or the OBSS R-TWT member STAs: (a) the STA does not need to apply the CR-TWT enhanced channel access rules; (b) however, it is not to solicit a DL transmission from its associated AP that interferes with the OBSS AP and/or the OBSS R-TWT member STAs.

The AP and/or its affiliated non-AP STA that support the CR-TWT feature should detect the OBSS topology or OBSS interference from OBSS devices before (re)scheduling the CR-TWT when considering the OBSS interference. The AP and/or its affiliated non-AP STA can decide OBSS interference based on several criteria including, but not limited to, a Received Signal Strength Indicator (RSSI), Received Channel Power Indicator (RCPI) or Signal Quality (SQ) of the received OBSS signal from the OBSS AP and/or the non-AP STAs.

### 6.7. Enabling C-RTWT Capability

In at least one embodiment, the UHR AP which supports the C-RTWT feature should indicate the capability of supporting C-RTWT. The signal can be carried in any desired manner, such as transmitted Beacon, Probe Response, (Re)Association Response frames and any other frames used for negotiating C-RTWT setup or scheduling with the UHR AP from an adjacent BSS.

In at least one embodiment, the UHR non-AP STA which supported the C-RTWT feature should indicate the capability of supporting C-RTWT. The signal can be carried in the (Re)Association Request frame or other management frames exchanged between the UHR non-AP STA and the associated UHR AP.

In at least one embodiment, the UHR AP and UHR non-AP STA can indicate if they support other coordinated schemes, such as Coordinated-Time Division Multiple Access (C-TDMA), Coordinated-Orthogonal Frequency-Division Multiple Access (C-OFDMA), C-SR, or similar, and whether and which combination of C-RTWT and other coordinated schemes are supported.

### 6.8. C-RTWT Negotiation

The process of C-RTWT negotiation could be performed, such as according to prior applications of the Applicant. In addition, a Multi-Access Point (M-AP) coordination mechanism (e.g., C-TDMA, C-OFDMA, C-SR) can be negotiated. The capability of supporting back-to-back CF-End frames, protection of the overlapping quiet interval of the OBSS R-TWT SP, and channel access rules before, at and after, the starting point of the OBSS R-TWT SP should also be negotiated during the C-RTWT negotiation stage.

### 7. Frame Formats

FIG. 15 illustrates 410 UHR capabilities and operations relevant subfields. The C-RTWT Support, C-TDMA Support, C-OFDMA Support and the C-SR Support subfields are designed to be included in UHR capabilities and in the operations relevant subfield to indicate support for C-RTWT, C-TDMA, C-OFDMA and/or C-SR. The UHR capabilities and operations relevant subfield can be carried in a Beacon, or other management frames. The transmitter of the frame, which carries the UHR capabilities and operations relevant subfields, shall set the corresponding Support subfield set to a first state (e.g., 1) if it supports that feature.

The STA which supports C-RTWT can decode the inter-BSS Physical layer Protocol Data Unit (PPDU) that has the C-RTWT Support subfield set to a first state (e.g., 1) and should continue parsing information including, but not limited to the BSSID, the R-TWT schedule, the quiet schedule, the STF offset, the operating channel information of the OBSS. The non-AP STA which supports C-RTWT can report the parsed information to its associated AP. The AP which supports C-RTWT should consider the parsed information when it updates and/or reschedules the C-RTWT SP in its own BSS.

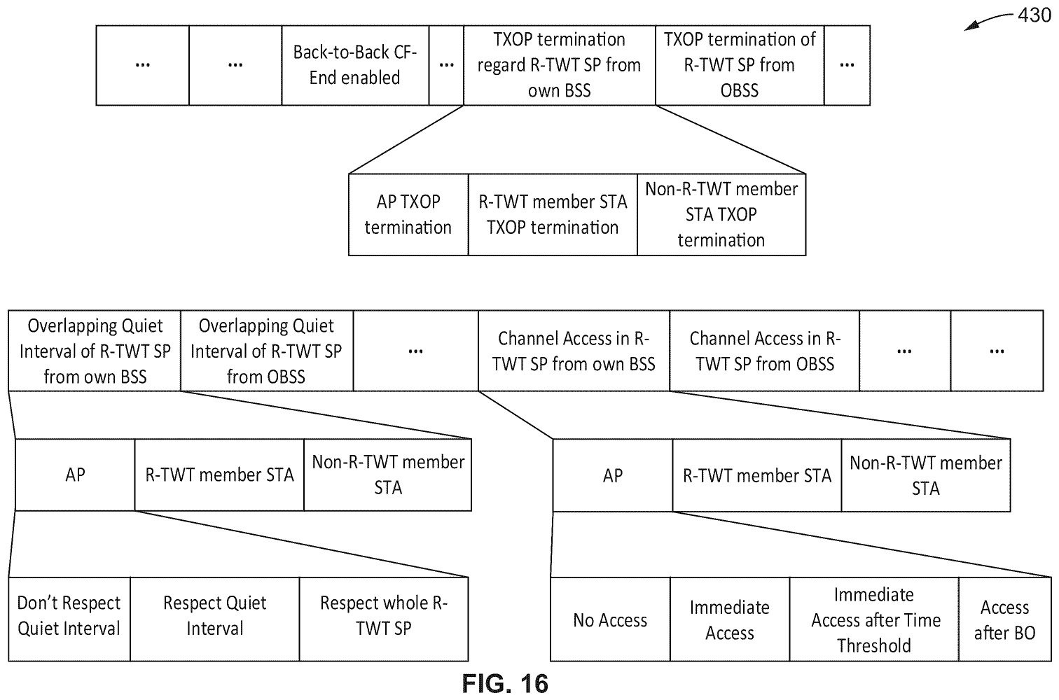

FIG. 16 illustrates 430 UHR C-RTWT negotiation relevant subfields. The Back-to-Back CF End enabled subfield is configured to indicate whether the back-to-back transmission of CF-End frames are enabled for the TXOP holder and the TXOP responder. If set to a first state (e.g., 1), then this indicates that the TXOP holder and the TXOP responder should transmit CF-End frames in a back-to-back manner to clear the basic NAV of OBSS. Otherwise, only the TXOP holder should transmit a CF-End frame to clear the basic NAV of OBSS.

The TXOP termination of the R-TWT SP from its own BSS and TXOP termination in regard to the R-TWT SP from the OBSS subfields are designed to indicate TXOP termination rules for different types of devices at the beginning of an R-TWT SP from its own BSS, or from an OBSS, respectively. Each of these two fields preferably consist of three subfields, including AP TXOP termination, R-TWT member STA TXOP termination and non-R-TWT member STA TXOP termination subfields, which indicate whether the transmitter has an AP, R-TWT member STA, or non-R-TWT member STA, will terminate the TXOP at the starting point of the R-TWT SP from its own BSS or from the OBSS, respectively. If set to a first state (e.g., 1), this indicates that the device will terminate the TXOP, otherwise, the device will not terminate the TXOP.

The Overlapping Quiet Interval of R-TWT SP from its own BSS and Overlapping Quiet Interval of R-TWT SP from OBSS subfields are designed to indicate that it respects the quiet interval rules for different types of devices that overlap at the beginning of an R-TWT SP from its own BSS or from the OBSS, respectively. Each of these two fields consist of three subfields, including AP, R-TWT member STA, and non-R-TWT member STA subfields, which indicate whether the transmitter is an AP, R-TWT member STA or non-R-TWT member STA, with respect to the overlapping quiet interval of the R-TWT SP from its own BSS, or from the OBSS, respectively. Each of the second tier subfields consist of three third-tier subfields, including Don't Respect Quiet Interval, Respect Quiet Interval and Respect whole R-TWT SP of its own R-TWT SP or OBSS SP, respectively.

If the Don't Respect Quiet Interval is set to a first state (e.g., 1), then this indicates that the device can start contending for the channel at the starting point of the R-TWT SP. If the Respect Quiet Interval is set to a first state (e.g., 1), then the device shall not contend for channel access during the overlapping quite interval of the R-TWT SP, yet can resume channel contention after the overlapping quiet interval in the remainder of the R-TWT SP.

If the Respect whole R-TWT SP is set to a first state (e.g., 1), then this indicates that the device shall not contend for channel access during the entire length of the R-TWT SP and shall resume channel contention after the R-TWT SP is either completed or truncated.

Channel Access in R-TWT SP from its own BSS and Channel Access in R-TWT SP from OBSS subfields are configured to indicate the channel access rules for different types of devices in an R-TWT SP from its own BSS or from OBSS, respectively. Each of these two fields consist of three subfields, including AP, R-TWT member STA and non-R-TWT member STA subfields, which indicate whether the transmitter as an AP, R-TWT member STA or non-R-TWT member STA, will process the channel access rule in the R-TWT SP from its own BSS or from OBSS, respectively. Each of the three second tier subfields consists of four third tier subfields, including No Access, Immediate Access, Immediate Access after Time Threshold and Access after BO in its own R-TWT SP or of OBSS SP, respectively.

If the No Access subfield is set to a first state (e.g., 1), then this indicates the device should not contend for channel access in the R-TWT SP.

If the Immediate Access subfield is set to a first state (e.g., 1), then this indicates that the device will immediately access the channel at the starting point of the R-TWT SP, if detect CCA idle.

If the Immediate Access after Time Threshold subfield is set to a first state (e.g., 1), then this indicates the device will immediately access the channel after an IFS, which could be SIFS, PIFS, or similar, or a certain time after the start point of R-TWT SP if detect CCA idle.

If the Access after BO subfield is set to a first state (e.g., 1), then this indicates that the device will perform EDCA-based channel access after the starting point of the R-TWT SP.

### 8. Flow Diagram

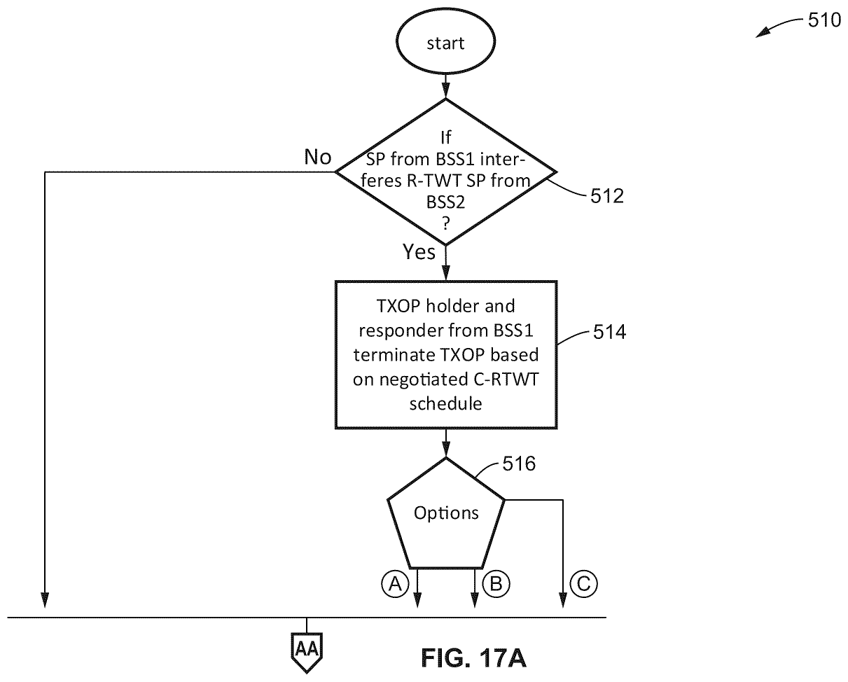

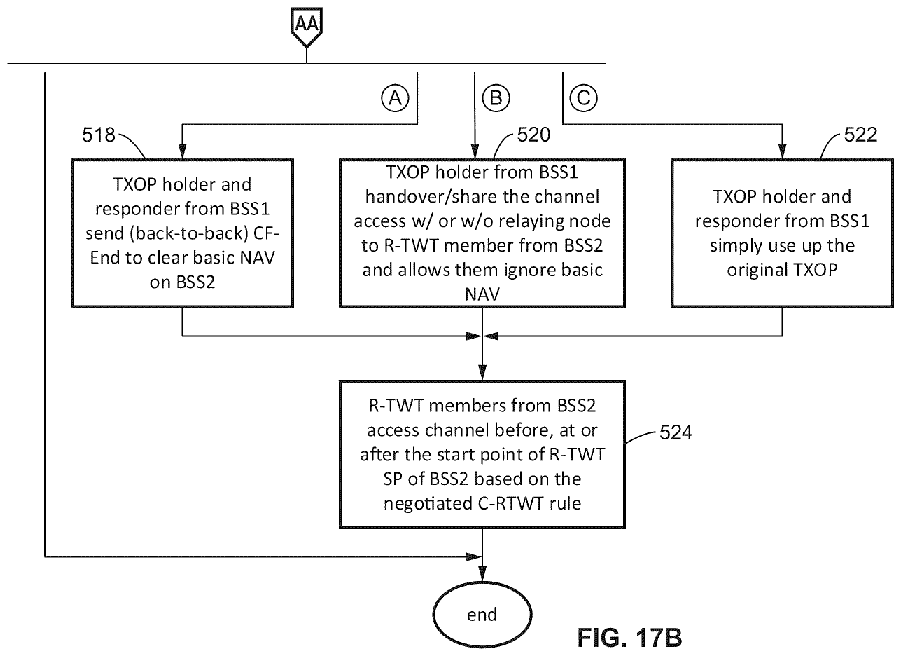

FIG. 17A and FIG. 17B illustrate an embodiment 510 of channel access operations for C-TDMA-based C-RTWT. Decision block 512 in FIG. 17A determines if the SP from BSS1 interferes with the R-TWT SP from BSS2. If there is no interference, then processing ends. Otherwise, the interference case is processed in block 514 with the TXOP holder and responder from BSS1 terminating the TXOP based on the negotiated C-RTWT schedule.

In decision block 516 multiple decision paths can be taken based on the conditions. In block 518 of FIG. 17B the TXOP holder and responder from BSS1 sends (back-to-back) CF-End to clear the basic NAV on BSS2, before proceeding to block 524. In block 520 the TXOP holder from BSS1 hands over or shares channel access, with or without, relaying the node to the R-TWT member from BSS2 and allows the R-TWT member to ignore the basic NAV, before execution proceeds to block 524. In block 522 the TXOP holder and responder from BSS1 simply utilize the remainder of the original TXOP, before execution proceeds to block 524.

In block 524 the R-TWT members from BSS2 accesses the channel before, at, or after, the starting point of the R-TWT SP of BSS2 based on the negotiated C-RTWT rule, before this part of the execution ends.

### 9. Examples of Channel Access Operations for C-TDMA-Based C-RTWT

### 9.1. Basic NAV Truncation Example

### 9.1.1. Basic NAV Truncation Based on Topology of FIG. 4

FIG. 18 illustrates a communication diagram 610 in the case of a TXOP holder AP1 interfering with AP2. The figure depicts communications involving AP1 156, AP2 158, STA1 160, STA2 162, STA3 164, and STA4 166.

In this example communication range of the TXOP holder (AP1 in this example) covers AP2, the communication range of the TXOP responder (STA1 or STA2) may or may not cover AP2. AP1 starts with a BO 611 and EDCA-based channel access and obtains the medium in TXOP period 612, for initiating a NAV-set sequence 614 (e.g., RTS/CTS frame exchanges) with STA1. AP2 and STA3 overhear (receive) 616 the communication of the NAV-set sequence from BSS1 and setup basic NAV 618. After a SIFS of the NAV-set sequence, AP1 transmits an initiator sequence 620, which may involve the exchange of multiple PPDUs between the TXOP holder and the TXOP responders. The exchange of NAV-set sequence and the initiator sequence from BSS1 causes AP2 and STA3 from BSS2 to detect the medium as CCA busy. At the end of the initiator sequence, the TXOP holder AP1 broadcasts a CF-End frame 622 as received 624, 626, 628, and 630 by other stations in range, to truncate the TXOP, shown ending 640, versus its nominal end 654. The CF-End frame could be received by STA1 and STA2 from BSS1, and AP2 and STA3 from BSS2. After a SIFS interval, the TXOP responder STA1 optionally broadcasts a CF-End frame 634, which is received 632, 635, 636, 638, to truncate the TXOP. The CF-End frame could be received by AP1 and STA2 from BSS1 and AP2 and STA3 from BSS2. By way of example STA4 is shown performing a BO 642, but does not obtain the channel. AP2 and STA3 received CF-End frames and should clear the basic NAV and are able to contend for channel access.

In this example, AP2 obtains channel access 644 in R-TWT SP 652, having an initial Quiet period 650. It should be noted that channel access for AP2 could be any of the following: (a) immediate access to the channel at the starting point of the R-TWT SP; (b) immediate access to the channel at the slot boundary of an IFS, which could be SIFS, PIFS, or similar, after the starting point of the R-TWT SP; or (c) immediately starting a BO at the starting point of R-TWT SP. The figure also shows a transmission of 646 from AP2 as received 648 by STA3.

FIG. 19 illustrates a communication diagram 710 in which the TXOP holder does not interfere with the OBSS AP, however, the TXOP responder is interfering with the OBSS AP. The figure depicts communications involving AP1 156, AP2 158, STA1 160, STA2 162, STA3 164, and STA4 166. The communication range of the TXOP holder (STA2) does extend to cover AP2, while TXOP responder (AP1) has a communication range which spans to covers AP2.

STA2 performs BO 611 followed by EDCA-based channel access in TXOP 612 and obtains the medium. STA2 then initiates a NAV-set 614 sequence (e.g., RTS/CTS frame exchanges) with AP1. AP2 and STA3 overhear (receive) at least a portion of the NAV-set sequence, from BSS1 and setup a basic NAV 618. After a SIFS of the NAV-set sequence, STA2 transmits an initiator sequence 620, which may involve the exchange of multiple PPDUs between the TXOP holder and the TXOP responder. The exchange of the NAV-set sequence and the initiator sequence from BSS1 causes AP2 and STA3 from BSS2 to detect the medium as CCA busy 616.

At the end of the initiator sequence, the TXOP holder STA2 broadcasts a CF-End frame 714, which is received 712 by AP1, to truncate the TXOP. The CF-End frame is received by AP1 from BSS1, but cannot be received by AP2 and STA3 from BSS2. After a SIFS time period following receipt of the CF-End frame from the TXOP holder STA2, TXOP responder AP1 broadcasts a CF-End frame 716 to truncate the TXOP, shown ending 728 versus its nominal end 729. The CF-End frame is (heard) received 718, 720, 722, and 724 by STA1, STA2 from BSS1 and the AP2 and STA3 from BSS2. AP2 and STA3 upon receiving the CF-End frames should clear the basic NAV 618 and are able to contend for channel access. The example shows STA3 and STA4 performing BOs 738, 726, however, they do not obtain the channel.

In this example AP2 obtains channel access 734 in R-TWT SP 730 within Quiet period 732. AP2 is shown transmitting 736, which is received 740 by STA3.

It should be appreciated that channel access for AP2 may comprise any of the following: (a) immediate access to the channel at the starting point of the R-TWT SP; (b) immediate access to the channel with an IFS, which could be SIFS, PIFS, or similar, after the starting point of the R-TWT SP; (c) immediately starting a BO at the starting point of the R-TWT SP.

9.1.2. Basic NAV Truncation based on Topology of FIG. 5

FIG. 20 illustrates an example embodiment 810 of a TXOP holder which does not interfere with the OBSS AP, and yet a TXOP responder can interfere with the OBSS AP. The figure depicts communications involving AP1 156, AP2 158, STA1 160, STA2 162, STA3 164, and STA4 166. The bulk of this diagram is the same as FIG. 19 using the same number references. The communication range of the TXOP holder (AP1) does not have a range which covers AP2, while the communication range of the TXOP responder (STA1) has a range which covers AP2.

After BO 812, AP1 starts EDCA-based channel access and obtains the medium in a TXOP shown with its duration 612. AP1 then initiates a NAV-set sequence 614 (e.g., RTS/CTS frame exchanges) with STA1. AP2 and STA3 overhear (receive) at least a portion of the NAV-set sequence from BSS1 and setup basic NAV 618. After a SIFS of the NAV-set sequence, AP1 transmits an initiator sequence 620, which may involve the exchange of multiple PPDUs between the TXOP holder and the TXOP responder. The exchange of the NAV-set sequence and the initiator sequence from BSS1 causes AP2 and STA3 from BSS2 to detect the medium as CCA busy 616. At the end of the initiator sequence, the TXOP holder AP1 broadcast a CF-End frame 622 to truncate the TXOP, shown ending 820 versus its nominal end 821. CF-End is also received 624, 626 by STA1 and STA2 from BSS1 but could only be received 812 by STA3 from BSS2. After a SIFS following receipt of the CF-End frame from the TXOP holder AP1, then the TXOP responder STA1 broadcasts a CF-End frame 634 to truncate the TXOP, and this frame can be received 632, by AP1 and STA2 receiving from BSS1 and AP2 and STA3 on BSS2 receiving 814, 816 this CF-End frame. It should be noted that STA2 does not necessarily receive the CF-end from STA1 when both STAs are at the edge of BSS1. Since the transmission power of a STA is usually less than the AP, whereby even though STA1 and STA2 are within an AP's coverage area, each STA may have its own coverage area which is smaller than the AP's coverage area and they may not overlap with each other. AP2 and STA3 upon receiving CF-End frames should clear the basic NAV and are then able to contend for channel access. The example shows STA3 and STA4 performing BOs 818 and 822, however, they do not obtain the channel. In this example, AP2 obtains channel access 828 in R-TWT SP 824 within Quiet period 826. AP2 is shown transmitting 830, which is received 832 by STA3.

It should be appreciated that channel access for AP2 can be obtained by any of the following: (a) immediately accessing the channel at the starting point of the R-TWT SP; (b) immediately accessing the channel after an IFS, which could be SIFS, PIFS, or similar, after the starting point of the R-TWT SP; (c) immediately starting a BO at the starting point of the R-TWT SP.

FIG. 21 illustrates an example 910 of a TXOP holder interfering with the OBSS AP, yet the TXOP responder does not interfere with the OBSS AP. The figure depicts communications involving AP1 156, AP2 158, STA1 160, STA2 162, STA3 164, and STA4 166. The bulk of this diagram is the same as FIG. 20 using the same number references.

The communication range of the TXOP holder (STA1) covers AP2, while the communication range of the TXOP responder (AP1) does not have the range to cover AP2. After BO 911, STA1 commences an EDCA-based channel access and obtains the medium. STA1 then initiates a NAV-set sequence 614 (e.g., RTS/CTS frame exchanges) with AP1. AP2 and STA3 overhear at least a portion of the NAV-set sequence from BSS1 and setup basic NAV 618. After a SIFS of the NAV-set sequence, STA1 transmits an initiator sequence 620, which may involve the exchange of multiple PPDUs between the TXOP holder and the TXOP responder. The exchange of NAV-set sequence and the initiator sequence from BSS1 causes AP2 and STA3 from BSS2 to detect the medium as CCA busy 616. At the end of the initiator sequence, the TXOP holder STA1 broadcasts 914 a CF-End frame to truncate the TXOP, and this frame can be received 912 by AP1 from BSS1 as well as being received 916, 918 by AP2 and STA3 from BSS2. After a SIFS following the receipt of the CF-End frame from the TXOP holder STA1, the TXOP responder AP1 should optionally broadcast 920 a CF-End frame to truncate the TXOP, shown ending 932 versus its nominal end 933. AP2 had performed BO 926 and obtained channel access for transmission, but this was terminated, and AP2 had to then obtain R-TWT SP 936 with its quiet interval 938. The CF-End should also be received 922, 924 by STA1 and STA2 from BSS1 and received 928 only by STA3 from BSS2. AP2 and STA3, upon receiving CF-End frames, should clear the basic NAV and are able to contend for channel access. In this example AP2 receives the CF-End Frame from STA1, but does not receive the CF-End frame from AP1 at a SIFS boundary, AP2 then contends for and obtains channel access 940. Previous to this STA4 and STA3 were seen contending 930, 934 for channel access, but they did not obtain the channel. AP2 may or may not terminate 932 the TXOP at the starting point of the R-TWT SP. If AP2 terminates the TXOP at the start point of R-TWT SP 936, in Quiet period 938, it will re-access the channel after the starting point of the R-TWT SP. AP2 is shown transmitting 942, which is received 944 by STA3.

It should be appreciated that channel access for AP2 may be obtained by any of the following: (a) gaining immediate channel access at the starting point of the R-TWT SP 936; (b) gaining immediate channel access after an IFS, which could be SIFS, PIFS, or similar, following the starting point of the R-TWT SP; (c) immediate commencing a BO at the starting point of the R-TWT SP.

10.2. Channel Access when BSS1 TXOP Interferes with the Starting Point of BSS2 R-TWT SP
10.2.1. Channel Access of BSS1 Devices after the Starting Point of BSS2 R-TWT SP

FIG. 22 illustrates an example 1010 of Channel Access for AP1, STA1 and STA2. The figure depicts communications involving AP1 156, AP2 158, STA1 160, STA2 162, STA3 164, and STA4 166. The bulk of this diagram is the same as FIG. 21 using many of the same reference numbers.

AP1 from BSS1 performs a BO 1011, obtains the channel, in a TXOP with duration 612 and initiates the NAV-set sequence 614 with the TXOP responder, which sets up a basic NAV 618 on AP2 and STA3 in BSS2. The TXOP holder AP1 and the TXOP responder (STA1 or STA2) commences the initiator sequence 620 and exchanges a SIFS after the NAV-set sequence. The exchange of NAV-set sequence and the initiator sequence from BSS1 causes AP2 and STA3 from BSS2 to detect the medium as CCA busy 616.

At the end of the initiator sequence, the TXOP holder and TXOP responder from BSS1 broadcast (back-to-back) CF-End frame(s) 1012, to truncate 1018 the TXOP; which would have nominal end 1032. The CF-End frame(s) could be received by AP1 from BSS1 and also received 1014, 1016 by AP2 and STA3 from BSS2.

After the BSS2 R-TWT SP commences in R-TWT SP 1020 with Quiet period 1022, STA2 from BSS1 does not interfere with the R-TWT SP member STAs in BSS2, thus it can perform regular EDCA-based channel access when it detects CCA idle, and in the example, they are seen communicating 1028, 1038, while STA4 recognizes 1030 the busy channel.

As STA1 and AP1 are interfering devices to R-TWT SP in BSS2, there are three options for AP1 and STA1 as following: (a) option i 1024, in which the interfering device does not respect the overlapped quiet interval of the OBSS R-TWT SP, thus it can contend for channel access during the overlapped quiet interval of the OBSS R-TWT SP; (b) option ii 1034 in which the interfering device respects the overlapped quiet interval of the OBSS R-TWT SP, and thus can only contend for channel access after the overlapped quiet interval of the OBSS R-TWT SP; (c) option iii 1040 in which the interfering device respects the entire length of the OBSS R-TWT SP, and thus only contends for channel access after the end of the OBSS R-TWT SP. It will be noted in the figure that ST2 is also performing backoffs 1026, 1036, but not able to access the channel.

10.2.2. Channel Access of BSS2 Devices after the Starting Point of BSS2 R-TWT SP

FIG. 23 illustrates an example 1110 of Channel Access for AP2, STA3 and STA4. The figure depicts communications involving AP1 156, AP2 158, STA1 160, STA2 162, STA3 164, and STA4 166. The bulk of this diagram is the same as FIG. 22 using the same number references.

AP1 of BSS1 performs a BO 1111, then obtains the channel in a TXOP having duration 612 and initiates the NAV-set sequence 614 with the TXOP responder, which sets up basic NAV 618 on AP2 and STA3 in BSS2. The TXOP holder AP1 and the TXOP responder STA1 or STA2 start the initiator sequence exchange 620 after a SIFS following the NAV-set sequence. The exchange of NAV-set sequence and the initiator sequence from BSS1 causes AP2 and STA3 from BSS2 to detect that the medium is CCA busy 616.

At the end of the initiator sequence, the TXOP holder and TXOP responder from BSS1 broadcast (back-to-back) CF-End frame(s) in a NAV-terminate sequence 1012, to truncate 1112 the TXOP, which would have had a nominal end 1113. In this example, this NAV-terminate sequence is also heard (received) 1014, 1016, by AP2 and STA3. The CF-End frame(s) could be received by AP1 from BSS1 and AP2 and STA3 from BSS2.

STA4 in BSS2 is not interfered with by frame exchanges, as mentioned above, and is shown performing a BO 1122 and obtaining the channel by starting EDCA-based channel access, in R-TWT SP 1114 with Quiet interval 1116. STA4 may terminate, in option i 1124, the BO at the starting point of the R-TWT SP, with the channel condition being considered busy 1130, if it respects the overlapping quiet interval; or STA4 can continue the BO as per option ii 1126 at the starting point of the R-TWT SP and perform EDCA-based channel access if it doesn't respect the overlapping quiet interval.

After the BSS2 R-TWT SP commences, AP2 and STA3 perform BOs 1118, 1120 and detect CCA idle at the starting point of the BSS2 R-TWT SP. STA3 commences EDCA-based channel access 1118 and AP2 can process one of following channel accesses: (a) obtain immediate channel access at the starting point of the R-TWT SP; (b) obtain immediate channel access after an IFS, which could be SIFS, PIFS, or similar, after the starting point of the R-TWT SP; (c) immediately commence a BO at the starting point of the R-TWT SP. The figure depicts a TXOP sequence 1128 between AP2 and STA3.

9.3. Channel Access when BSS1 R-TWT TXOP Interferes with the Starting Point of the BSS2 R-TWT SP

### 9.3.1. BSS1 Continues its R-TWT SP at the Starting Point of BSS2 R-TWT SP

FIG. 24 illustrates an example 1210 of applying an optional NAV-terminate sequence. The example is based on the topology of FIG. 4 and depicts communications involving AP1 156, AP2 158, STA1 160, STA2 162, STA3 164, and STA4 166.

Devices from BSS1 and BSS2 have completed C-RTWT negotiation 1212. AP1, STA1 and STA2 from BSS1 detect CCA idle and start BO 1214, 1216, 1220. If STA1 and/or STA2 respect the overlapping quiet interval of BSS1 R-TWT SP, they shall stop (discontinue) their BO during the overlapping quiet interval of BSS1 R-TWT SP, otherwise they can continue the BO. In this example, AP1 is the first to obtain channel access in R-TWT SP 1222, in Quiet interval 1224, and to have a TXOP duration 1226, and it initiates the NAV-set sequence 1228 with the TXOP responder STA1, in response to which STA2 senses CCA busy 1230 and sets up a basic NAV 618 on AP2 and STA3 in BSS2.

The TXOP holder AP1 and the TXOP responder STA1, start an initiator sequence exchange 1232 after a SIFS following the NAV-set sequence, which passes the starting point of the BSS2 R-TWT SP. The exchange of the NAV-set sequence 1228 and the initiator sequence 1232 from BSS1 causes AP2 and STA3 from BSS2 detect medium as CCA busy 1230. STA2 is seen in a busy state 1233.

At the end of the initiator sequence 1232 from BSS1, the TXOP holder AP1 and TXOP responder STA1 from BSS1 can exchange an optional NAV-terminate sequence 1240 to clear the basic NAV 618 which is set on AP2 and STA3 from BSS2; this NAV-termination sequence is also heard by (received) 1240, 1242, by AP2 and STA3. AP2 and STA3 detect CCA idle and then STA3 optionally commences a BO 1243 during the overlapping quiet interval in BSS2 R-TWT SP, which depends on whether STA3 follows the overlapping quiet interval rule. AP2 could perform channel accesses according to one of the following: (a) immediately accessing the channel at the starting point of the R-TWT SP 1234, Quiet Interval 1236; (b) immediately accessing the channel after an IFS, which could be SIFS, PIFS, or similar, following the starting point of the R-TWT SP; (c) immediately commencing a BO at the starting point of the R-TWT SP.

AP2 obtains channel access then initiates the NAV-set sequence 1246, having a TXOP duration 1238, with the TXOP responder STA3, which causes STA4 to sense CCA busy and it sets up a 1245 basic NAV on AP1 and STA1 in BSS1. The TXOP holder AP2 and the TXOP responder STA3 commence an initiator sequence exchange 1248 after a SIFS following the NAV-set sequence. The exchange of NAV-set sequence and the initiator sequence from BSS2 causes AP1 and STA1 from BSS1 to detect medium as CCA busy 1244. STA4 in BSS2 is seen as busy 1250 during the TXOP duration.

FIG. 25 illustrates an example 1310 of a handshake frame exchange for C-RTWT sharing. The example is also based on the topology of FIG. 4 and depicts communications involving AP1 156, AP2 158, STA1 160, STA2 162, STA3 164, and STA4 166.

Devices from BSS1 and BSS2 have completed C-RTWT negotiation 1212. AP1, STA1 and STA2 from BSS1 detect CCA idle and start BOs 1214, 1216 and 1220. If STA1 and/or STA2 respect the overlapping quiet interval of BSS1 R-TWT SP, they shall stop (discontinue) their BO during the overlapping quiet interval of BSS1 R-TWT SP, otherwise they can continue the BO.

In this example, AP1 is the first to obtain the channel, in R-TWT SP 1222, with Quiet interval 1224, with TXOP duration 1226, and initiates a NAV-set sequence 1228 with the TXOP responder STA1, which STA2 senses as CCA busy and sets up a basic NAV 618 on AP2 and STA3 in BSS2. STA2 of BSS1 was also seen performing a backoff 1220, and then determining that the medium is busy 1233.

The TXOP holder AP1 and the TXOP responder STA1 commence the initiator sequence exchange after a SIFS following the NAV-set sequence, which passes the starting point of the BSS2 R-TWT SP. The exchange of NAV-set sequence and the initiator sequence 1232 from BSS1 causes AP2 and STA3 from BSS2 to detect that the medium is CCA busy 1230. It should be noted that the R-TWT SP and Quiet interval (QE) are previously negotiated at least between BSS2 AP and BSS2 STAs. They could also be negotiated with BSS1 AP for C-TWT. However, it is unknown whether the AP of BSS1 and the STAs within BSS1 will respect this schedule. This is not a triggered event, it is a pre-negotiated event that is scheduled at a specific time.

At the end of the initiator sequence 1232 from BSS1, the TXOP holder AP1 transmits a C-RTWT sharing sequence 1312, as received 1316 by AP2 of BSS2 to directly share channel access to AP2, and during this time STA1, STA2, STA3 and STA4 detect this exchange as the media being busy 1314, 1318.

AP2 ignores the basic NAV after receiving the C-RTWT sharing sequence, and STA3 also ignores the basic NAV by overhearing the C-RTWT sharing sequence. AP2 obtains shared channel access and initiates the NAV-set sequence 1322 with the TXOP responder STA3. This causes STA4 to sense CCA busy 1326 and it sets up a basic NAV 1245 on AP1 and STA1 in BSS1. The TXOP holder AP2 and the TXOP responder STA3 start the initiator sequence exchange 1324 after a SIFS following the NAV-set sequence. The exchange of NAV-set sequence and the initiator sequence, within TXOP duration 1238, seen following the quiet interval 1236 of the R-TWT SP 1234, from BSS2 causes AP1 and STA1 from BSS1 detect the medium as CCA busy 1320; while STA4 is also seen as busy 1326 during TXOP duration 1238.

FIG. 26 illustrates an example 1410 of a handshake frame exchange with a relay for C-RTWT sharing. The example is based on the topology of FIG. 5 and depicts communications involving AP1 156, AP2 158, STA1 160, STA2 162, STA3 164, and STA4 166.

Devices from BSS1 and BSS2 have completed their C-RTWT negotiation 1212. AP1, STA1 and STA2 from BSS1 detect CCA idle and start BO 1214, 1216 and 1220. If STA1 and/or STA2 respect the overlapping quiet interval of BSS1 R-TWT SP, they shall stop (discontinue) their BO during the overlapping quiet interval of BSS1 R-TWT SP, otherwise they could continue their BO.

In this example, AP1 first obtains the channel in R-TWT SP 1222, starting with a Quiet interval 1224 and initiates the NAV-set sequence 1226 in TXOP duration 1226 with the TXOP responder STA1, which causes STA2 to recognize CCA busy 1230 and it sets up basic NAV 618 on AP2 and STA3 in BSS2. The TXOP holder AP1 and the TXOP responder STA1 start (commence) the initiator sequence 1232 exchange after a SIFS following the NAV-set sequence, which passes the starting point of the BSS2 R-TWT SP. The exchange of NAV-set sequence and the initiator sequence from BSS1 causes AP2 and STA3 from BSS2 detect medium as CCA busy 1230. At the end of the initiator sequence from BSS1, the TXOP holder AP1 exchanges C-RTWT sharing sequence 1412 with BSS2 AP2 (received as 1414) through the relay of STA1 and/or STA3 to share channel access to AP2.

AP2 obtains the shared channel access then initiates the NAV-set sequence 1322 in TXOP duration 1238 with the TXOP responder STA3, which causes STA4 to sense CCA busy and it sets up the basic NAV 1245 on AP1 and STA1 in BSS1. The TXOP holder AP2 and the TXOP responder STA3 start (commence) initiator sequence 1324 exchange after a SIFS following the NAV-set sequence 1322. The exchange of the NAV-set sequence and the initiator sequence from BSS2 causes AP1 and STA1 from BSS1 to detect the medium as CCA busy 1320. STA4 also is recognized on BSS2 as being busy 1326.

### 9.3.2. BSS1 Truncates its R-TWT SP a Certain Duration Before the Starting Point of BSS2 R-TWT SP

FIG. 27 illustrates an example 1510 of BSS1 R-TWT SP terminated before the starting point of BSS2 R-TWT SP. The example is based on either topology shown in FIG. 4 or FIG. 5, and depicts communications involving AP1 156, AP2 158, STA1 160, STA2 162, STA3 164, and STA4 166.

In this example, devices from BSS1 and BSS2 have completed the C-RTWT negotiation 1212. AP1, STA1 and STA2 from BSS1 detect CCA idle and start BOs 1214, 1216, 1220. If STA1 and/or STA2 respect the overlapping quiet interval of BSS1 R-TWT SP, they shall stop (discontinue) their BOs during the overlapping quiet interval 1224 of BSS1 R-TWT SP 1222, otherwise they could continue performing their BOs. AP1 first obtains the channel and initiates the NAV-set sequence 1228 with the TXOP responder STA1, which causes STA2 to sense CCA busy 1233 and it sets up basic NAV 618 on AP2 and STA3 in BSS2.

The TXOP holder AP1 and the TXOP responder STA1 start (commence) the initiator sequence exchange 1232 after a SIFS following the NAV-set sequence. The exchange of NAV-set sequence 1228 and the initiator sequence 1232, within TXOP duration 1612, in BSS1 causes AP2 and STA3 from BSS2 to detect the medium as CCA busy 1230. At the end of the initiator sequence from BSS1, there is still time remaining before the starting point of BSS2 R-TWT SP 1234, and its quiet interval 1236. AP2 and STA3 detect CCA idle and contend 1517 for channel access.

The TXOP holder, in this case AP2 or STA3, obtains channel access then initiates the NAV-set sequence 1518 with the TXOP responder, which causes STA4 to sense CCA busy 1524 and set up a basic NAV 1516 on AP1 and STA1 in BSS1. AP1 and STA1 are shown in a busy state 1514. The TXOP holder, such as AP2 or STA3 in this example, may continue or terminate the TXOP at the starting point of BSS2 R-TWT SP, if the TXOP termination is applied, STA3 optionally starts (commences) BO 1519 during the overlapping quiet interval 1236 in BSS2 R-TWT SP 1234, which depends on whether STA3 follows the overlapping quiet interval rule. AP2 can perform one of following to obtain channel access: (a) immediately access the channel at the starting point of the R-TWT SP; (b) immediately access the channel after an IFS, which could be SIFS, PIFS, or similar, following the starting point of the R-TWT SP; or (c) immediately start (commence) its BO at the starting point of the R-TWT SP. During this time STA4 has recognized the channel as being busy 1524.

AP2 obtains channel access then initiates the NAV-set sequence 1520 with TXOP responder STA3, which causes STA4 to sense CCA busy and it sets up basic NAV 1523 on AP1 and STA1 in BSS1. The TXOP holder AP2 and the TXOP responder STA3 start (commence) the initiator sequence exchange 1522 after a SIFS following the NAV-set sequence. The exchange of NAV-set sequence 1520 and initiator sequence 1522 within TXOP duration 1238 in BSS2 causes AP1 and STA1 from BSS1 to detect the medium as CCA busy 1521.

### 9.3.3. BSS1 Truncates its R-TWT SP at the Starting Point of BSS2 R-TWT SP

FIG. 28 illustrates an example 1610 of applying an optional NAV-terminate sequence as based on the topology shown in FIG. 4, and depicts communications involving AP1 156, AP2 158, STA1 160, STA2 162, STA3 164, and STA4 166.

Devices from BSS1 and BSS2 have completed a C-RTWT negotiation 1212. AP1, STA1 and STA2 from BSS1 detect CCA idle and start BOs 1214, 1216 and 1220. If STA1 and/or STA2 respect the overlapping quiet interval of BSS1 R-TWT SP, they shall stop (discontinue) their BO during the overlapping quiet interval 1224 of BSS1 R-TWT SP 1222, otherwise they can continue with the BOs. In this example, AP1 first obtains the channel, and at the start of TXOP duration 1611, initiates the NAV-set sequence 1228 (at the beginning of TXOP duration 1611) with the TXOP responder STA1 in response to which STA2 senses CCA busy 1233 and sets up basic NAV 618 on AP2 and STA3 in BSS2. The TXOP holder AP1 and the TXOP responder STA1 start the initiator sequence exchange 1232 after a SIFS following the NAV-set sequence. The exchange of the NAV-set sequence and the initiator sequence from BSS1 cause AP2 and STA3 from BSS2 to detect the medium as CCA busy 1230.

At the end of the initiator sequence from BSS1, the TXOP holder AP1 and TXOP responder STA1 from BSS1 should exchange the optional NAV-terminate sequence 1612 to terminate the TXOP 1614 before its nominal end 1627 and clear the basic NAV 618 set on AP2 and STA3 from BSS2, which is heard (received) by AP2 and STA3 1616, 1618.

The end point of the NAV-termination sequence directly precedes the starting point of BSS2 R-TWT SP 1234, with its quiet interval 1236, and TXOP duration 1238. In this example, AP2 and STA3 are performing BOs 1620 and both detect CCA idle, after which STA3 optionally starts (commences) a BO during the overlapping quiet interval in BSS2 R-TWT SP, which is depending on whether STA3 follows the overlapping quiet interval rule. AP2 can obtain channel access by one of the following mechanisms: (a) immediately obtain channel access at the starting point of the R-TWT SP; (b) immediately obtain channel access after an IFS, which could be SIFS, PIFS, or similar, following the starting point of the R-TWT SP; or (c) immediately commence a BO at the starting point of R-TWT SP.

AP2 obtains channel access then initiates the NAV-set sequence 1626 with the TXOP responder STA3, which causes STA4 to sense CCA busy 1630 and set up a basic NAV 1624 on AP1 and STA1 in BSS1. The TXOP holder AP2 and the TXOP responder STA3 starts (commences) the initiator sequence exchange 1628 after a SIFS following the NAV-set sequence. The exchange of the NAV-set sequence 1626 and the initiator sequence 1628 from BSS2 causes AP1 and STA1 from BSS1 to detect the medium as CCA busy 1622.

FIG. 29 illustrates an example 1710 of a handshake frame exchange for C-RTWT sharing, and is based on the topology shown in FIG. 4. The example depicts communications involving AP1 156, AP2 158, STA1 160, STA2 162, STA3 164, and STA4 166.

Devices from BSS1 and BSS2 have completed a C-RTWT negotiation 1212. AP1, STA1 and STA2 from BSS1 detect CCA idle and start BOs 1214, 1216, and 1220. If STA1 and/or STA2 respect the overlapping quiet interval 1224 of BSS1 R-TWT SP 1222, they shall stop (discontinue) their BO during the overlapping quiet interval of BSS1 R-TWT SP, otherwise they can continue the BO.

In this example, AP1 first obtains the channel and initiates the NAV-set sequence 1228 (at the beginning of TXOP duration 1711) with the TXOP responder STA1. In response to the NAV-set sequence STA2 senses CCA busy 1233 and sets up a basic NAV 618 on AP2 and STA3 in BSS2. The TXOP holder AP1 and the TXOP responder STA1 starts (commences) the initiator sequence exchange 1232 after a SIFS following the NAV-set sequence. The exchange of the NAV-set sequence and the initiator sequence from BSS1 causes AP2 and STA3 from BSS2 to detect the medium as CCA busy 1230.

At the end of the initiator sequence from BSS1, the TXOP holder AP1 exchanges C-RTWT sharing sequence 1712, 1716 with BSS2 AP2 directly to share TXOP 1719 channel access to AP2, while STA1, STA2, STA3 and STA4 are in a busy condition 1714, 1718. The end of the C-RTWT sharing sequence immediately precedes the starting point of BSS2 R-TWT SP 1234, with its quiet interval 1236, over a TXOP duration 1238. AP2 ignores the basic NAV after receiving the C-RTWT sharing sequence, and STA3 also ignores the basic NAV in response to overhearing (receiving) the C-RTWT sharing sequence.

AP2 obtains shared channel access and initiates the NAV-set sequence 1724 with the TXOP responder STA3. This causes STA4 to sense CCA busy 1728 and it sets up basic NAV 1720 on AP1 and STA1 in BSS1. The TXOP holder AP2 and the TXOP responder STA3 starts (commences) the initiator sequence exchange 1726 after a SIFS following the NAV-set sequence. The exchange of the NAV-set sequence and the initiator sequence from BSS2 causes AP1 and STA1 from BSS1 to detect the medium as CCA busy 1722.

After initiator sequence 1726, AP1 and AP2 perform another C-RTWT sharing sequence 1730, 1734, while STA1, STA2 and STA3 and STA4 recognize the CCA busy 1732, 1736. After this sequence, AP1 and STA1 perform a NAV-set sequence 1738, while AP2 and STA3, as well as STA2 sense CCA busy 1740.

FIG. 30 illustrates an example 1810 of BSS1 R-TWT SP terminated at the starting point of BSS2 R-TWT SP, with the example being based on the topology shown in either FIG. 4 or FIG. 5. The example depicts communications involving AP1 156, AP2 158, STA1 160, STA2 162, STA3 164, and STA4 166.

Devices from BSS1 and BSS2 have completed C-RTWT negotiation 1212. AP1, STA1 and STA2 from BSS1 detect CCA idle and start BOs 1214, 1216 and 1220. If STA1 and/or STA2 respect the overlapping quiet interval 1224 of BSS1 R-TWT SP 1222, they shall stop (discontinue) their BO during the overlapping quiet interval of BSS1 R-TWT SP, otherwise they can continue the BO.

AP1 is the first to obtain the channel, at the beginning of the TXOP duration 1812, and initiates the NAV-set sequence 1228 with the TXOP responder STA1, which cause STA2 to sense CCA busy 1233 and it sets up a basic NAV 618 on AP2 and STA3 in BSS2. The TXOP holder AP1 and the TXOP responder STA1 start (commence) an initiator sequence exchange 1232 after a SIFS following the NAV-set sequence. The exchange of NAV-set sequence and the initiator sequence from BSS1 causes AP2 and STA3 from BSS2 to detect the medium as CCA busy 1230. The end of the initiator sequence from BSS1 immediately precedes the starting point of BSS2 R-TWT SP 1234, with its quiet interval 1236, over a TXOP duration 1238. At the starting point of BSS2 R-TWT SP, AP1 and STA1 detect CCA idle 1814. AP2 can obtain channel access by one of the following: (a) immediately obtain channel access at the starting point of the R-TWT SP; (b) immediately obtain channel access after an IFS, which could be SIFS, PIFS, or similar, after the starting point of the R-TWT SP; or (c) immediately commence a BO at the starting point of R-TWT SP.

AP2 obtains channel access and initiates the NAV-set sequence 1818 with the TXOP responder STA3, which causes STA4 to sense CCA busy 1822, and set up a basic NAV 1816 on AP1 and STA1 in BSS1. The TXOP holder AP2 and the TXOP responder STA3 start (commence) the initiator sequence exchange 1820 after a SIFS following the NAV-set sequence. The exchange of NAV-set sequence and the initiator sequence from BSS2 causes AP1 and STA1 from BSS1 detect medium as CCA busy 1814.

FIG. 31 illustrates an example 1910 of a handshake frame exchange with relay for C-RTWT sharing and is based on the topology shown in FIG. 5, and depicts communications involving AP1 156, AP2 158, STA1 160, STA2 162, STA3 164, and STA4 166.

Devices from BSS1 and BSS2 have completed their C-RTWT negotiation 1212. AP1, STA1 and STA2 from BSS1 detect CCA idle and start BOs 1214, 1216, and 1220. If STA1 and/or STA2 respect the overlapping quiet interval 1224 of BSS1 R-TWT SP 1222, they shall stop (discontinue) their BOs during the overlapping quiet interval of BSS1 R-TWT SP; otherwise, they can continue their BO.

In this example, AP1 is first to obtain the channel and initiates the NAV-set sequence 1228 at the beginning of TXOP duration 1912 with the TXOP responder STA1, which causes STA2 to sense CCA busy 1233 and it sets up a basic NAV 618 on AP2 and STA3 in BSS2. The TXOP holder AP1 and the TXOP responder STA1 start an initiator sequence exchange 1232 after a SIFS following the NAV-set sequence. The exchange of the NAV-set sequence and the initiator sequence from BSS1 causes AP2 and STA3 from BSS2 to detect the medium as CCA busy 1230.

At the end of the initiator sequence from BSS1, the TXOP holder AP1 exchanges a C-RTWT sharing sequence 1914, 1920 with BSS2 AP2 through the relay of STA1 and/or STA3 to share TXOP channel access 1916 to AP2. The end of the C-RTWT sharing sequence from BSS1 immediately (directly) precedes the starting point of BSS2 R-TWT SP 1234, with its quiet interval 1236, over its TXOP duration 1238. AP2 and STA3 hear (receive) the C-RTWT sharing sequence and should ignore the basic NAV.

AP2 obtains the shared channel access then initiates the NAV-set sequence 1928 with the TXOP responder STA3, which causes STA4 to sense CCA busy 1932 and to set up a basic NAV 1924 on AP1 and STA1 in BSS1. The TXOP holder AP2 and the TXOP responder STA3 start the initiator sequence exchange 1930 after a SIFS following the NAV-set sequence. The exchange of NAV-set sequence and the initiator sequence from BSS2 causes AP1 and STA1 from BSS1 detect medium as CCA busy 1922.

### 9.3.4. C-RTWT Schedule-Based Channel Access

FIG. 32 illustrates an example 2010 of C-RTWT scheduling-based channel access, with the example being based on the topology shown in either FIG. 4 or FIG. 5. The example depicts communications involving AP1 156, AP2 158, STA1 160, STA2 162, STA3 164, and STA4 166.

Devices from BSS1 and BSS2 have completed C-RTWT negotiation 1212. According to the C-RTWT negotiated schedule AP1 from BSS1 may obtain channel access by one of following: (a) immediately access the channel at the starting point of the R-TWT SP; (b) immediately access the channel after an IFS, which could be SIFS, PIFS, or similar, following the starting point of the R-TWT SP; or (c) immediately commence a BO at the starting point of R-TWT SP.

If neither STA1 or STA2 contend for channel access, then AP1 is seen performing a BO 2012 and is first to obtain the channel of R-TWT-SP 1222, having quiet interval 1224, and showing the allocated TXOP duration 2014, whereupon it initiates the TXOP sequence exchange 2016 with the TXOP responder STA1 for a schedule TXOP duration, which cause STA2 to sense CCA busy 2018 and it sets up a basic NAV 2022 on AP2 and STA3 in BSS2. The exchange of the TXOP sequence from BSS1 causes AP2 and STA3 from BSS2 to detect the medium as CCA busy 2020. The TXOP sequence from BSS1 is completed prior to the starting point of BSS2 R-TWT SP 1234, with its quiet interval 1236, although the allocated TXOP duration 2028 commences prior to the start of the R-TWT SP.

AP2 or STA3 directly obtain channel access at the starting point of the allocated TXOP duration, and then initiate a TXOP sequence 2030 with the TXOP responder, which causes STA4 to sense CCA busy 2032 and set up a basic NAV 2026 on AP1 and STA1 in BSS1. The exchange of the TXOP sequence from BSS2 causes AP1 and STA1 from BSS1 to detect the medium as CCA busy 2024.

### 10. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the specified function(s).

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA is operating in the wireless communications protocol as either an Access Point (AP) STA or a non-AP STA, for communicating with other STAs using a carrier sense multiple access/collision avoidance (CSMA/CA) mechanism and controlling channel access within a coordinated channel sharing mechanism based on a coordinated restricted-target wake time (R-TWT) as (C-RTWT); (e)(ii) receiving input from ultra high reliability (UHR) STAs that they support R-TWT; and (e)(iii) applying C-RTWT to interfering service periods (SPs), which arise when a transmission from a TXOP holder, or a TXOP responder, from a first BSS interferes with transmissions and/or receptions of R-TWT members and the R-TWT scheduling AP of an R-TWT SP from an adjacent BSS.

A method of communicating in a wireless network, comprising: (a) performing a wireless communications protocol for stations (STAs) wirelessly communicating with other STAs on a IEEE 802.11 wireless local area network (WLAN); (b) wherein said STA operates in the wireless communications protocol as either an Access Point (AP) STA or a non-AP STA, for communicating with other STAs using a carrier sense multiple access/collision avoidance (CSMA/CA) mechanism and controlling channel access within a coordinated channel sharing mechanism based on a coordinated restricted-target wake time (R-TWT) as (C-RTWT); (c) receiving input from ultra high reliability (UHR) STAs that they support R-TWT; and (d) applying C-RTWT to interfering services periods (SPs), which arise when a transmission from a TXOP holder, or a TXOP responder, from a first BSS interferes with transmissions and/or receptions of R-TWT members and the R-TWT scheduling AP of an R-TWT SP from an adjacent BSS.

An apparatus in which C-RTWT should be applied to interfering SPs, which occurs when a TXOP holder or a TXOP responder's transmission from one BSS interfering the transmission and/or reception of R-TWT members and the R-TWT scheduling AP of an R-TWT SP from the adjacent BSS; wherein UHR devices should indicate if it supports C-RTWT or other coordinated mechanisms.

The apparatus or method of any preceding implementation, wherein said coordinated channel sharing mechanism is selected from a group of channel sharing mechanisms consisting of: coordinated time division multiple access (C-TDMA), coordinated orthogonal frequency division multiple access (C-OFDMA) and coordinated spatial reuse (C-SR).

The apparatus or method of any preceding implementation, wherein the interfering SP is an interfering TXOP or interfering R-TWT SP.

The apparatus or method of any preceding implementation, wherein the interference from an overlapping basic service set (OBSS) is determined by the station which detects or receives an inter-BSS frame with certain conditions indicative of an interference conflict.

The apparatus or method of any preceding implementation, wherein the conditions indicative of the interference conflict are determined by a signal quality measurement being outside of a signal quality threshold.

The apparatus or method of any preceding implementation, wherein the signal quality measurement is selected from the group of signal quality measurements consisting of received signal strength indicator (RSSI), received channel power indicator (RCPI), or received signal-to-noise indicator (RSNI).

The apparatus or method of any preceding implementation, wherein APs involved in C-RTWT network allocation vector (NAV) truncation perform broadcasting of OBSS NAV truncation information in their own BSSs toward overcoming any hidden terminal issue.

The apparatus or method of any preceding implementation, wherein the STA as a UHR TXOP holder from a first BSS sends a CF-End frame to a TXOP responder in a neighboring BSS to clear the basic network allocation vector (NAV) of that neighboring BSS, wherein the STA receives from the TXOP responder, as UHR TXOP holder in that BSS, a CF-End frame in confirmation.

The apparatus or method of any preceding implementation, wherein said STA, if operating as an AP in a first BSS, negotiates a C-RTWT schedule and channel access rules with an AP of another BSS toward preventing an interference with the R-TWT SP between BSSs.

The apparatus or method of any preceding implementation, wherein the STA operates as an R-TWT scheduling AP, or R-TWT member STA, or non-R-TWT member STA, which establishes a protection level of an overlapping quiet interval of an R-TWT SP within the neighboring BSS, protecting it from interference by TXOPs or R-TWT SPs, transmitted in the first BSS.

The apparatus or method of any preceding implementation, wherein said protection level is selected from a group of protection levels consisting of: (a) not respecting the OBSS R-TWT SP quiet interval, (b) only respecting the quiet interval of the OBSS R-TWT SP, and (c) not contending during an entire duration of the OBSS R-TWT.

The apparatus or method of any preceding implementation, wherein the protection level to not respect the OBSS R-TWT SP quiet interval allows STAs in the first BSS to start contending for the channel at the starting point of the OBSS R-TWT SP.

The apparatus or method of any preceding implementation, wherein the protection level of only respecting the quiet interval of the OBSS R-TWT SP, prevents the STA of the first BSS from contending for channel access during a quiet interval overlapping the OBSS R-TWT SP, yet the STA can resume channel contention after the overlapping quiet interval, during the remainder of the OBSS R-TWT SP.

The apparatus or method of any preceding implementation, wherein the protection level of not contending during an entire duration of the OBSS R-TWT prevents the STA and other STAs of the first BSS from contending for channel access during the entire OBSS R-TWT SP, wherein the STA and other STAs of the first BSS can resume channel contention only after the OBSS R-TWT SP is either completed or truncated.

The apparatus or method of any preceding implementation, wherein the protection level to be supported is based on performing a comparison between buffered unit (BU) priority and the OBSS R-TWT TID.

The apparatus or method of any preceding implementation, wherein termination of the TXOP in the first BSS at the starting point of an R-TWT SP from the second BSS is determined based on C-RTWT negotiation.

The apparatus or method of any preceding implementation, wherein only the AP of the first BSS can terminate the TXOP at the starting point of the R-TWT SP from the second BSS.

The apparatus or method of any preceding implementation, wherein any STA of the first BSS can terminate the TXOP at the starting point of the R-TWT SP from the second BSS.

The apparatus or method of any preceding implementation, wherein the AP STA and at least a portion of the non-AP stations in the first BSS, end their TXOP at the starting point of the R-TWT SP from the second BSS

The apparatus or method of any preceding implementation, wherein the UHR devices support C-RTWT from adjacent BSSs should setup/negotiate the C-RTWT schedule and channel access rules to prevent SP from one BSS interfering R-TWT SP from another BSS.

The apparatus or method of any preceding implementation, wherein the interfering SP could be a TXOP that may or may not necessarily within an R-TWT SP. The interfering SP could be an interfering TXOP or interfering R-TWT SP.

The apparatus or method of any preceding implementation, wherein the OBSS interference is determined by the receiver that detects/receives the inter-BSS frame with certain conditions such as measurement during a threshold of the signal quality (e.g., RSSI, RCPI, or RSNI).

The apparatus or method of any preceding implementation, wherein the UHR device as the TXOP holder from one BSS should send a CF-End frame to clear the basic NAV of the neighboring BSS, and the UHR device as the TXOP responder from the same BSS could send another CF-End frame a SIFS after receiving the CF-End frame for the TXOP holder to clear the basic NAV of the neighboring BSS.

The apparatus or method of any preceding implementation, wherein the UHR device operates as R-TWT scheduling AP or R-TWT member STA or non-R-TWT member STA could have different capabilities to support the protection level of the overlapping quiet interval of the R-TWT SP from the neighboring BSS.

The apparatus or method of any preceding implementation, wherein the interfering SP is a TXOP from one BSS to its adjacent BSS. The UHR devices in this BSS could have different level to terminate TXOP at the start point of the R-TWT SP in the adjacent BSS. The UHR devices from the adjacent BSS could access channel after the start point of the R-TWT SP.

The apparatus or method of any preceding implementation, wherein the interfering SP is a R-TWT SP from one BSS to its adjacent BSS. The UHR devices in this BSS could have different level to terminate TXOP at the start point of the R-TWT SP in the adjacent BSS. The UHR devices from the adjacent BSS could access channel after the start point of the R-TWT SP.

The apparatus or method of any preceding implementation, wherein the protection level is to not respect the OBSS R-TWT SP quiet interval, wherein the device can start contending for the channel at the start point of the OBSS R-TWT SP.

The apparatus or method of any preceding implementation, wherein the protection level is to respect only the OBSS R-TWT SP quiet interval, the device shall not contend for channel access during the overlapping quiet interval of the OBSS R-TWT SP but can resume channel contention after the overlapping quiet interval in the rest of the OBSS R-TWT SP.

The apparatus or method of any preceding implementation, wherein the protection level is to not contend the whole OBSS R-TWT SP, the device shall not contend for channel access during the whole OBSS R-TWT SP and shall resume channel contention after the OBSS R-TWT SP completed or truncated.

The apparatus or method of any preceding implementation, wherein the determination of protection level supported by the device is based on the comparison between the device buffered units (BU)s priority and the OBSS R-TWT TID.

The apparatus or method of any preceding implementation, wherein the TXOP termination rule requires only UHR AP to end the TXOP at the starting point of the R-TWT SP of the adjacent BSS.

The apparatus or method of any preceding implementation, wherein the UHR termination rule requires only the UHR non-AP STA to end the TXOP with respect to the starting point of the R-TWT SP from the adjacent BSS.

The apparatus or method of any preceding implementation, wherein the UHR termination rule requires the UHR AP and all its associated UHR non-AP STAs to end their TXOP at the starting point of the R-TWT SP of the adjacent BSS.

The apparatus or method of any preceding implementation, wherein the UHR termination rule requires the UHR AP and part of its associated UHR non-AP STAs to end their TXOP at the starting point of the R-TWT SP of the adjacent BSS.

The apparatus or method of any preceding implementation, wherein the UHR termination rule requires neither the UHR AP nor its associated UHR non-AP STAs to end their TXOP before the starting point of the OBSS R-TWT SP.

The apparatus or method of any preceding implementation, wherein the UHR devices from the adjacent BSS detects CCA idle at the starting point of the R-TWT SP, and process different channel access based on the negotiated C-RTWT.

The apparatus or method of any preceding implementation, wherein the UHR device is an AP, and it immediately accesses the channel at the starting point of the R-TWT SP; and wherein it can immediately access the channel after an IFS, which could be SIFS, PIFS, etc., after the starting point of the R-TWT SP; or wherein it could immediately start a BO at the starting point of R-TWT SP.

The apparatus or method of any preceding implementation, wherein the UHR device is a non-AP STA, and it accesses the channel according to its supported protection level of the overlapping quiet interval.

The apparatus or method of any preceding implementation, wherein the TXOP termination rule requires the R-TWT scheduling AP and R-TWT schedule STA from the interfering BSS to continue the TXOP and passes the starting point of the R-TWT SP of the adjacent BSS.

The apparatus or method of any preceding implementation, wherein the TXOP termination rule requires the R-TWT scheduling AP and R-TWT scheduled STA from the interfering BSS to terminate TXOP withing a certain time before the starting point of the R-TWT SP of the adjacent BSS.

The apparatus or method of any preceding implementation, wherein the TXOP termination rule requires the R-TWT scheduling AP and R-TWT scheduled STA from BSS1 to terminate the TXOP at the starting point of the R-TWT SP of the adjacent BSS.

The apparatus or method of any preceding implementation, wherein the R-TWT scheduled AP and R-TWT scheduled STA from interfering with the BSS by transmitting an optional NAV-terminate sequence, such as back-to-back CF-End or other PPDUs capable to clear basic NAV in the adjacent BSS.

The apparatus or method of any preceding implementation, wherein the R-TWT scheduling AP is prevented from interfering with the BSS by directly exchanging a C-RTWT sharing/negotiation sequence with the R-TWT scheduling AP from the adjacent BSS to hand over the channel access and/or to negotiate a C-RTWT schedule.

The apparatus or method of any preceding implementation, wherein the R-TWT scheduling AP from the interfering BSS exchanges a C-RTWT sharing or negotiation sequence with the R-TWT scheduling AP from the adjacent BSS through relay to the non-AP STA(s) to hand over the channel access and/or to negotiate a C-RTWT schedule.

The apparatus or method of any preceding implementation, wherein the applied TXOP termination rule also applies for UHR devices.

The apparatus or method of any preceding implementation, wherein the R-TWT scheduling AP from the adjacent BSS ignore the basic NAV and can signal the R-TWT scheduled STAs to ignore the basic NAV.

The apparatus or method of any preceding implementation, wherein the R-TWT scheduled STAs from the adjacent BSS also clears the basic NAV after overhearing the C-RTWT sharing or negotiation sequence.

The apparatus or method of any preceding implementation, wherein the R-TWT scheduling AP from the adjacent BSS ignore the basic NAV and signal the R-TWT scheduled STAs to ignore the basic NAV.

The apparatus or method of any preceding implementation, wherein the R-TWT scheduled STAs from the adjacent BSS also clear the basic NAV in response to overhearing the C-RTWT sharing or negotiation sequence.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to +5%, less than or equal to +4%, less than or equal to +3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to 5°, less than or equal to 4°, less than or equal to 3°, less than or equal to ±2°, less than or equal to 1°, less than or equal to 0.5°, less than or equal to 0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA is operating in the wireless communications protocol as either an Access Point (AP) STA or a non-AP STA, for communicating with other STAs using a carrier sense multiple access/collision avoidance (CSMA/CA) mechanism and controlling channel access within a coordinated channel sharing mechanism based on a coordinated restricted-target wake time (R-TWT) as (C-RTWT);
(ii) receiving input from ultra high reliability (UHR) STAs that they support R-TWT; and
(iii) applying C-RTWT to interfering service periods (SPs), which arise when a transmission from a TXOP holder, or a TXOP responder, from a first BSS interferes with transmissions and/or receptions of R-TWT members and the R-TWT scheduling AP of an R-TWT SP from an adjacent BSS.

2. The apparatus of claim 1, wherein said coordinated channel sharing mechanism is selected from a group of channel sharing mechanisms consisting of: coordinated time division multiple access (C-TDMA), coordinated orthogonal frequency division multiple access (C-OFDMA) and coordinated spatial reuse (C-SR).

3. The apparatus of claim 1, wherein the interfering SP is an interfering TXOP or interfering R-TWT SP.

4. The apparatus of claim 1, wherein the interference from an overlapping basic service set (OBSS) is determined by the station which detects or receives an inter-BSS frame with certain conditions indicative of an interference conflict.

5. The apparatus of claim 4, wherein the conditions indicative of the interference conflict are determined by a signal quality measurement being outside of a signal quality threshold.

6. The apparatus of claim 5, wherein the signal quality measurement is selected from the group of signal quality measurements consisting of received signal strength indicator (RSSI), received channel power indicator (RCPI), or received signal-to-noise indicator (RSNI).

7. The apparatus of claim 1, wherein APs involved in C-RTWT network allocation vector (NAV) truncation perform broadcasting of OBSS NAV truncation information in their own BSSs toward overcoming any hidden terminal issue.

8. The apparatus of claim 1, wherein the STA as a UHR TXOP holder from a first BSS sends a CF-End frame to a TXOP responder in a neighboring BSS to clear the basic network allocation vector (NAV) of that neighboring BSS, wherein the STA receives from the TXOP responder, as UHR TXOP holder in that BSS, a CF-End frame in confirmation.

9. The apparatus of claim 1, wherein said STA, if operating as an AP in a first BSS, negotiates a C-RTWT schedule and channel access rules with an AP of another BSS toward preventing an interference with the R-TWT SP between BSSs.

10. The apparatus of claim 1, wherein the STA operates as an R-TWT scheduling AP, or R-TWT member STA, or non-R-TWT member STA, which establishes a protection level of an overlapping quiet interval of an R-TWT SP within the neighboring BSS, protecting it from interference by TXOPs or R-TWT SPs, transmitted in the first BSS.

11. The apparatus of claim 10, wherein said protection level is selected from a group of protection levels consisting of: (a) not respecting the OBSS R-TWT SP quiet interval, (b) only respecting the quiet interval of the OBSS R-TWT SP, and (c) not contending during an entire duration of the OBSS R-TWT.

12. The apparatus of claim 11, wherein the protection level to not respect the OBSS R-TWT SP quiet interval allows STAs in the first BSS to start contending for the channel at the starting point of the OBSS R-TWT SP.

13. The apparatus of claim 11, wherein the protection level of only respecting the quiet interval of the OBSS R-TWT SP, prevents the STA of the first BSS from contending for channel access during a quiet interval overlapping the OBSS R-TWT SP, yet the STA can resume channel contention after the overlapping quiet interval, during the remainder of the OBSS R-TWT SP.

14. The apparatus of claim 11, wherein the protection level of not contending during an entire duration of the OBSS R-TWT prevents the STA and other STAs of the first BSS from contending for channel access during the entire OBSS R-TWT SP, wherein the STA and other STAs of the first BSS can resume channel contention only after the OBSS R-TWT SP is either completed or truncated.

15. The apparatus of claim 11, wherein the protection level to be supported is based on performing a comparison between buffered unit (BU) priority and the OBSS R-TWT TID.

16. The apparatus of claim 1, wherein termination of the TXOP in the first BSS at the starting point of an R-TWT SP from the second BSS is determined based on C-RTWT negotiation.

17. The apparatus of claim 16, wherein only the AP of the first BSS can terminate the TXOP at the starting point of the R-TWT SP from the second BSS.

18. The apparatus of claim 16, wherein any STA of the first BSS can terminate the TXOP at the starting point of the R-TWT SP from the second BSS.

19. The apparatus of claim 16, wherein the AP STA and at least a portion of the non-AP stations in the first BSS, end their TXOP at the starting point of the R-TWT SP from the second BSS.

20. A method of communicating in a wireless network, comprising:
(a) performing a wireless communications protocol for stations (STAs) wirelessly communicating with other STAs on a IEEE 802.11 wireless local area network (WLAN);
(b) wherein said STA operates in the wireless communications protocol as either an Access Point (AP) STA or a non-AP STA, for communicating with other STAs using a carrier sense multiple access/collision avoidance (CSMA/CA) mechanism and controlling channel access within a coordinated channel sharing mechanism based on a coordinated restricted-target wake time (R-TWT) as (C-RTWT);
(c) receiving input from ultra high reliability (UHR) STAs that they support R-TWT; and
(d) applying C-RTWT to interfering services periods (SPs), which arise when a transmission from a TXOP holder, or a TXOP responder, from a first BSS interferes with transmissions and/or receptions of R-TWT members and the R-TWT scheduling AP of an R-TWT SP from an adjacent BSS.
